(19) United States
(12) Patent Application Publication
(10) Pub. No.: US 2026/0080510 A1
(43) Pub. Date: Mar. 19, 2026

(54) IMAGE ANALYSIS DEVICE AND METHOD

(71) Applicant: Panasonic Intellectual Property Management Co., Ltd., Osaka (JP)

(72) Inventors: Akihiro TANAKA, Osaka (JP); Taku Matsushita, Osaka (JP)

(21) Appl. No.: 19/395,260

(22) Filed: Nov. 20, 2025

Related U.S. Application Data
(63) Continuation of application No. PCT/JP2024/017265, filed on May 9, 2024.

(30) Foreign Application Priority Data
May 26, 2023 (JP) 2023-087161

(51) Int. Cl. G06T 5/50; G06T 1/60

(52) U.S. Cl. CPC G06T 5/50; G06T 1/60; G06T 2207/20221; G06T 2207/30242

(57) ABSTRACT

An image analysis device for analyzing a moving image captured by one or more cameras in a site where a plurality of processes is performed, including: a storage that stores moving image data indicating a captured moving image of a process area in which each process is performed; and a controller that detects an anomaly period where a progress status of the processes deviates from a predetermined reference set for each process. The controller extracts, from the captured moving image, a first moving image of a first process area where a first process is performed in the anomaly period, and a second moving image related to the first moving image, based on the detected anomaly period. The second moving image includes one or both of image capturing results of a second process area located near the first process area and a second process performed before and/or after the first process.

### TECHNICAL FIELD

The present disclosure relates to an image analysis device and an image analysis method using an image recognition technology.

### BACKGROUND ART

JP 2008-059322 A discloses a work management system that distributes video information obtained by photographing each process with a camera to a manager of a production line in a process of a production site. The work management system measures a work time of each process by a measuring means including a switch, a sensor, and the like, and when determining that the measured work time is shorter or longer than a internally set standard time by a predetermined time or more, the work management system displays video information of a work corresponding to the measured work time on a monitor for the manager. Thereby, the work management system aims to provide efficient line management by allowing the manager to watch only abnormal condition videos moving image of only abnormal state vides without necessity of checking the abnormal state of the process from all videos.

### SUMMARY

The present disclosure provides an image analysis device and image analysis method that facilitate analyzing performed processes from moving images of a site where the processes are performed, the moving images being captured by a camera.

One aspect of the present disclosure provides an image analysis device for analyzing a moving image captured by one or more cameras in a site where a plurality of processes is performed. The image analysis device includes a storage and a controller. The storage stores moving image data indicating a captured moving image of a process area in which each process is performed in the site. The controller detects an anomaly period in which a progress status of the plurality of processes deviates from a predetermined reference set for each process in the plurality of processes, based on status information indicating the progress status. The controller extracts, from the captured moving image indicated by the moving image data, a first moving image of a first process area and a second moving image related to the first moving image, based on the detected anomaly period, the first process area including a place where a first process is performed in the anomaly period. The second moving image includes one or both of an image capturing result of a second process area located near the first process area and an image capturing result of a second process performed in at least one of a preceding period before the first process or a subsequent period after the first process.

These general and specific aspects may be implemented by a system, a method, and a computer program, and a combination thereof.

According to the image analysis device and the image analysis method of the present disclosure, it becomes easier to analyze performed processes from moving images of a site where the processes are performed, the moving images being captured by the camera.

### BRIEF DESCRIPTION OF DRAWINGS

FIG. 1 is a diagram illustrating an overview of a work analysis system according to a first embodiment;

FIG. 2 is a block diagram illustrating a configuration of a work analysis device in the work analysis system;

FIG. 3 is a functional block diagram illustrating a functional configuration of the work analysis device of the first embodiment;

FIGS. 4A and 4B are diagrams for explaining information stored in a storage of the work analysis device;

FIG. 5 is a diagram for explaining an overview of an operation of the work analysis system in the first embodiment;

FIG. 6 is a flowchart illustrating operations of a moving image obtainer and a work detector in the work analysis device of the first embodiment;

FIG. 7 is a flowchart illustrating operations of an anomaly detector and a moving image extractor in the work analysis device of the first embodiment;

FIGS. 8A and 8B are diagrams for explaining a setting screen in the work analysis system;

FIG. 9 is a diagram for explaining an analysis screen in the work analysis system;

FIG. 10 is a flowchart illustrating detection processing of an anomaly period in the work analysis device of the first embodiment;

FIG. 11 is a flowchart illustrating generation processing of an extracted moving image in the work analysis device of the first embodiment;

FIG. 12 is a diagram for explaining the generation processing of an extracted moving image in the first embodiment;

FIG. 13 is a flowchart illustrating the generation processing of an extracted moving image in a first modification of the first embodiment;

FIG. 14 is a diagram for explaining the generation processing of an extracted moving image in the first modification;

FIG. 15 is a flowchart illustrating generation processing of an extracted moving image in a second modification of the first embodiment;

FIG. 16 is a diagram for explaining an outline of an operation of the work analysis system in a second embodiment;

FIG. 17 is a flowchart illustrating detection processing of an anomaly period in the work analysis device of the second embodiment;

FIG. 18 is a diagram for explaining generation of an extracted moving image in the work analysis device of the second embodiment; and

FIG. 19 is a diagram for explaining a work site to which the work analysis system is applied in a further modification of the first embodiment.

### DETAILED DESCRIPTION

Hereinafter, an embodiment will be described in detail with reference to the drawings as appropriate. However, unnecessarily detailed description may be omitted. For example, a detailed description of a well-known matter and a repeated description of substantially the same configuration may be omitted. This is to avoid unnecessary redundancy of the following description and to facilitate understanding of those skilled in the art. Note that the inventor(s) provides the accompanying drawings and the following description in order for those skilled in the art to fully understand the present disclosure, and does not intend to limit the subject matter described in the claims by the accompanying drawings and the following description.

### (First Embodiment)

### 1. Configuration

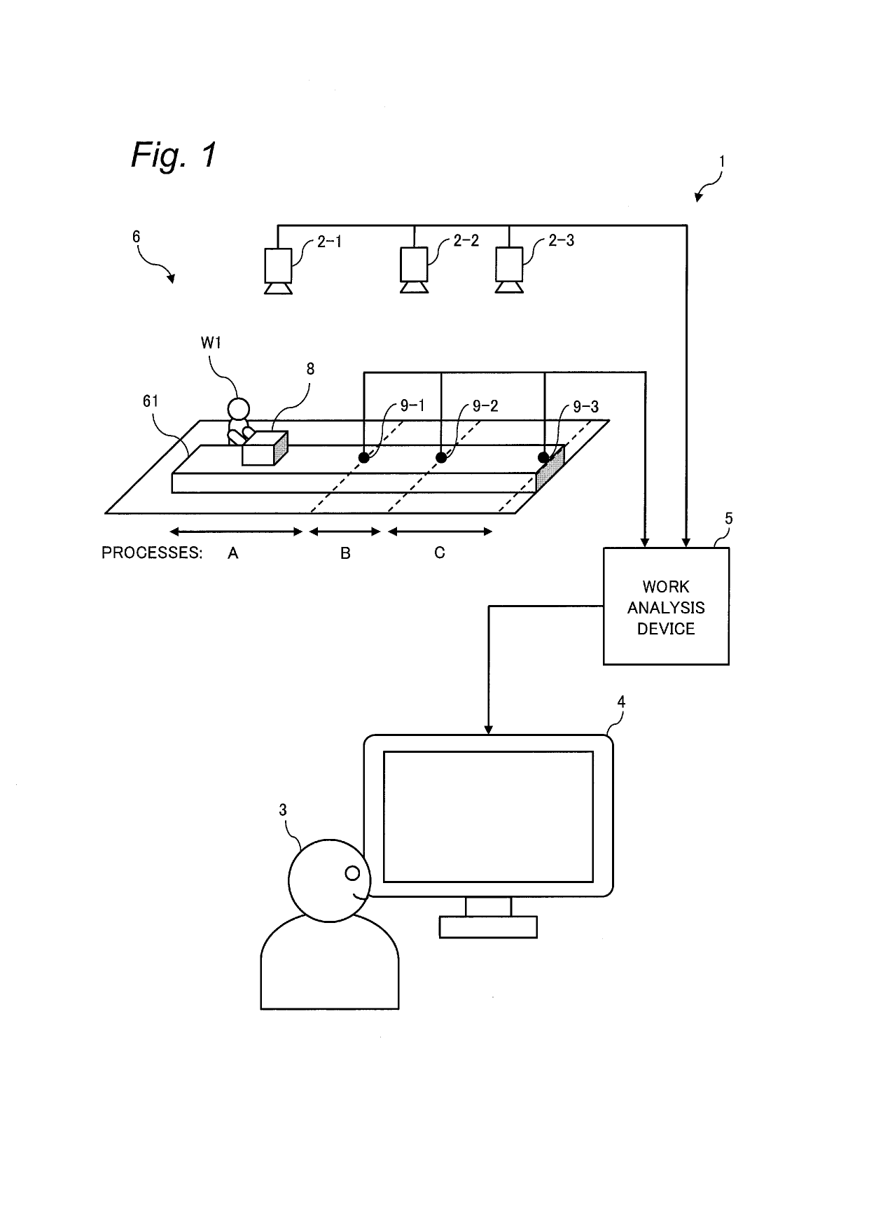

A work analysis system according to a first embodiment will be described with reference to FIG. 1. FIG. 1 is a diagram illustrating an overview of a work analysis system 1 of the present embodiment.

### 1-1. System overview

The work analysis system 1 illustrated in FIG. 1 includes a plurality of cameras 2-1, 2-2, and 2-3, in addition to a work analysis device 5 which is an example of the image analysis device of the present disclosure. The present system 1 is applied to an application for analyzing efficiency or the like of an operator such as a worker W1 or the like who performs work including a plurality of process in a work site 6 such as a factory, for example. The present system 1 may include a monitor 4 for presenting an analysis screen used for analysis to a user 3 such as a manager of the work site 6 or a person in charge of the analysis, for example. In the example of FIG. 1, the system 1 further comprises a plurality of sensors 9-1, 9-2, 9-3.

In the example of FIG. 1, a conveyor line 61 is installed in a work site 6, and an article 8 such as a product is conveyed on the conveyor line 61. In the work site 6 of the present example, a plurality of processes A, B, and C in the work are sequentially and repeatedly performed by the worker W1 moving along the conveyor line 61. As each of processes A to C, for example, in the work of manufacturing the article 8, component picking, assembly, inspection, and the like are performed. The cameras 2-1, 2-2, and 2-3 of the present embodiment respectively corresponding to the processes A, B, and C are arranged to capture a range in which the processes A, B, and C are performed in the work site 6, respectively. Hereinafter, the cameras 2-1 to 2-3 are also collectively referred to as a camera 2.

The camera 2 of the present system 1 repeats an image capturing operation at a predetermined cycle in the work site 6 and generates moving image data indicating a moving image including captured images, for example. The camera 2 is connected to the work analysis device 5 so that moving image data is transmitted to the work analysis device 5, for example.

The sensors 9-1, 9-2, and 9-3 of the present system 1 are arranged to detect the article 8 passing on the conveyor line 61 at positions where the respective processes A to C end in the work site 6, corresponding to the processes A, B, and C, respectively. Hereinafter, the sensors 9-1 to 9-3 are also collectively referred to as a sensor 9. The sensor 9 is, for example, a photoelectric sensor such as an infrared sensor, and is connected to the work analysis device 5 such that sensor data indicating a detection result of the article 8 is transmitted to the work analysis device 5.

In the present system 1, the work analysis device 5 analyzes, for example, a work period or the like that is a length of time during which the work is performed by the worker W1 for each of the processes A to C, and various types of information such as the work period or the like are presented to the user 3 on the monitor 4. For example, the user 3 can analyze an anomaly state in which the work period is excessively longer than a predetermined reference from the presented work period. Furthermore, in the present system 1, the user 3 can analyze the moving image for each of the processes A to C captured by each camera 2 and examine a factor of the anomaly state and the like.

Although one worker W1 is illustrated in FIG. 1, the number of workers in the work site 6 may be two or more. In this case, the work analysis device 5 may analyze the work period or the like for each worker. In the present system 1, the anomaly state or the like in the work period for each worker may be analyzed.

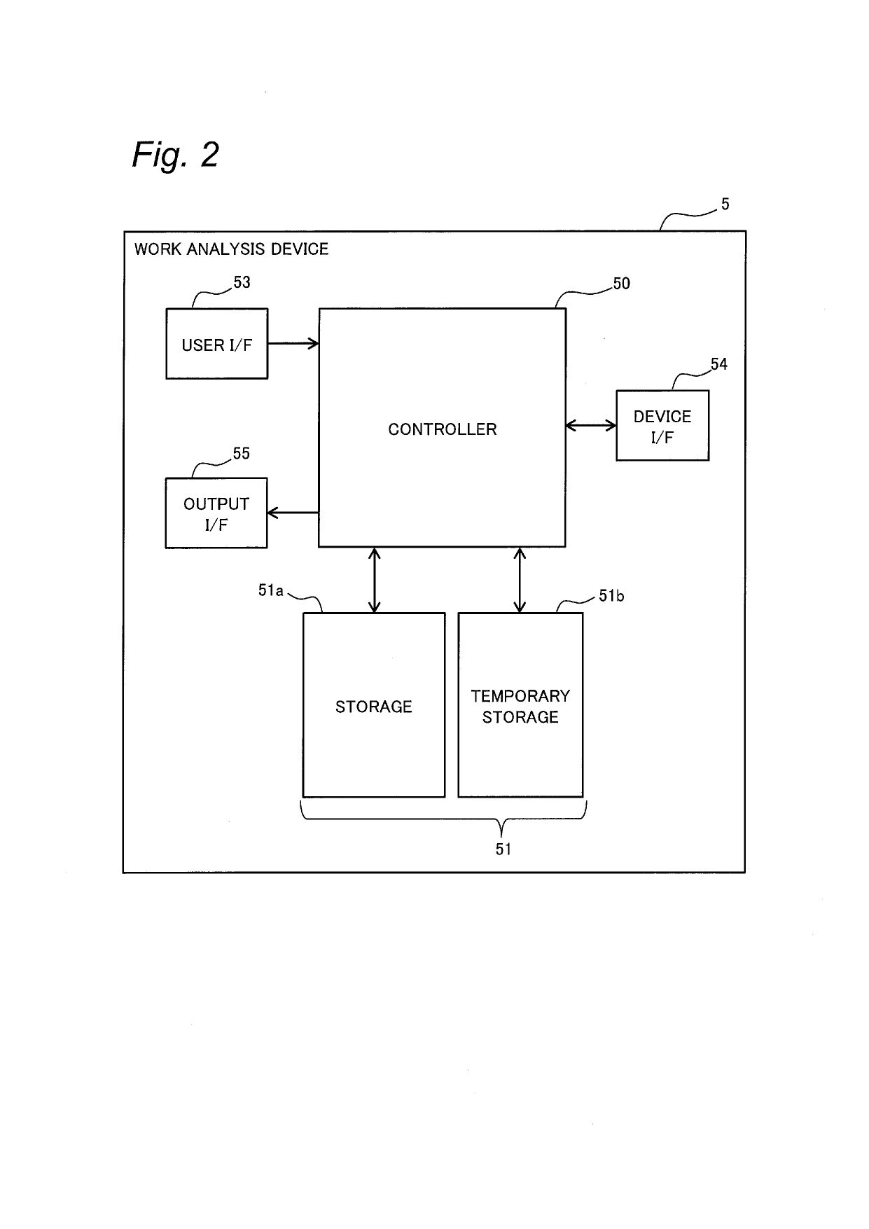

The work analysis device 5 is implemented with an information processing device such as a server device, for example. The work analysis device 5 is communicably connected to an external information processing device such as a PC including the monitor 4. A configuration of the work analysis device 5 will be described with reference to FIG. 2.

1-2. Configuration of work analysis device FIG. 2 is a block diagram illustrating a configuration of the work analysis device 5. The work analysis device 5 illustrated in FIG. 2 includes a controller 50, a storage 51, a user interface 53, a device interface 54, and an output interface 55. Hereinafter, the interface is abbreviated as “I/F”.

The controller 50 includes, for example, a CPU or an MPU that realizes a predetermined function in cooperation with software, and controls overall operations of the work analysis device 5. The controller 50 reads data and programs stored in the storage 51, performs various arithmetic processing, and realizes various functions.

The controller 50 executes, for example, a program including a command group for realizing functions of the work analysis device 5. The above program may be provided from a communication network such as the Internet, or may be stored in a portable recording medium. Furthermore, the controller 50 may include an internal memory as a temporary storage area that holds various data and programs.

The controller 50 may be a hardware circuit such as a dedicated electronic circuit designed to realize a predetermined function or a reconfigurable electronic circuit. The controller 50 may include various semiconductor integrated circuits such as a CPU, an MPU, a GPU, a GPGPU, a TPU, a microcomputer, a DSP, an FPGA, and an ASIC.

The storage 51 is a storage medium that stores programs and data required for implementing the functions of the work analysis device 5. As illustrated in FIG. 2, the storage 51 includes a storage 51a and a temporary storage 51b.

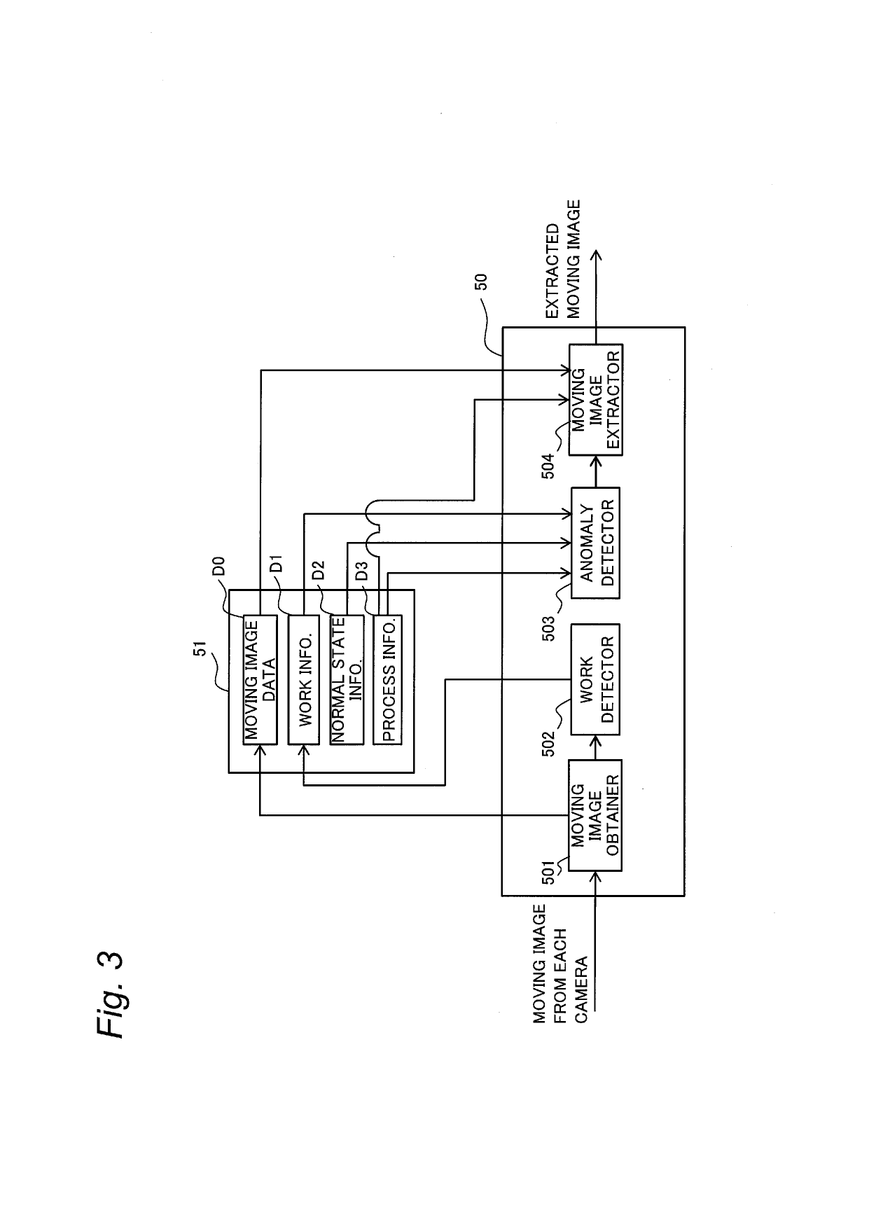

The storage 51a stores parameters, data, control programs, and the like for realizing a predetermined function. The storage 51a includes, for example, an HDD or an SSD. For example, the storage 51a stores, further to the above-described program, moving image data D0, work information D1, normal state information D2, process information D3 (see FIG. 3), and the like to be described later.

The temporary storage 51b includes, for example, a RAM such as a DRAM or an SRAM, and temporarily stores (i.e., holds) data. The temporary storage 51b holds, for example, a detection result of an anomaly period to be described later. In addition, the temporary storage 51b may function as a work area of the controller 50, and may be configured by a storage area in an internal memory of the controller 50.

The user interface 53 is a general term for operation members that receive an operation of user 3. The user interface 53 includes, for example, any one of a keyboard, a mouse, a trackpad, a touchpad, a button, a switch, and the like, or a combination thereof. The user interface 53 acquires various types of information input by operations by the user 3.

The device I/F 54 is a circuit for connecting an external device such as the camera 2 to the work analysis device 5. The device I/F 54 performs data communication according to a predetermined communication standard. Examples of the predetermined standard include USB, HDMI (registered trademark), IEEE1394, IEEE802.11, and Bluetooth (registered trademark). The device I/F 54 is an example of an acquisition circuit that receives various information from an external device in the work analysis device 5. In the work analysis system 1, the work analysis device 5 acquires moving image data indicating a moving image captured by the camera 2 via the device I/F 54, for example.

The output I/F 55 is a circuit for outputting information. The output I/F 55 outputs moving image data and the like to an external display device such as a monitor and a projector for displaying various types of information in compliance with, for example, the HDMI standard.

The configuration of the work analysis device 5 as described above is an example, and the configuration of the work analysis device 5 is not limited thereto. The work analysis device 5 may be configured by various computers including a personal computer (PC). In addition to or instead of the output I/F 55, the work analysis device 5 may include a display including a liquid crystal display or an organic EL display as a built-in display device, for example. In addition, the image analysis method of the present embodiment may be performed in distributed computing.

In addition to or instead of the above configuration, the work analysis device 5 may have a configuration that communicates with an external information processing device via a communication network. For example, the user interface 53 may be configured to receive an operation by an external information processing device connected via a communication network. Furthermore, the output I/F 55 may transmit various types of information to an external information processing device via a communication network.

In addition, the acquisition circuit in the work analysis device 5 may be realized by cooperation with various kinds of software in the controller 50 or the like. The acquisition circuit in the work analysis device 5 may acquire various types of information by reading various types of information stored in various storage media (e.g., the storage 51) to the work area of the controller 50.

1-3. Functional configuration of work analysis device A functional configuration of the work analysis device 5 of the present embodiment will be described with reference to FIG. 3.

FIG. 3 is a functional block diagram illustrating a functional configuration of the work analysis device 5 of the present embodiment. The work analysis device 5 includes, for example, a moving image obtainer 501, a work detector 502, an anomaly detector 503, and a moving image extractor 504 that function in cooperation with software in the controller 50. In the work analysis device 5, for example, the normal state information D2 and the process information D3 are stored in advance in the storage 51a of the storage 51. The normal state information D2 indicates a predetermined reference conditioning a state in which the processes in the work by the worker W1 or the like in the work site 6 is assumed to be normally performed. The process information D3 indicates a relationship between each camera 2 and a position where the processes A to C are performed in the work site 6.

The moving image obtainer 501 sequentially acquires, from each camera 2 via the device I/F 54 or the like, moving image data D0 indicating a moving image captured by each camera 2, in a frame cycle or the like of the moving image, for example. The moving image obtainer 501 stores the moving image data D0 acquired in association with a captured time of each frame in the storage 51 and inputs the moving image data D0 to the work detector 502, for example.

The work detector 502 detects a process of the work shown in each frame image based on moving image data D0 input frame by frame, for example. For example, the work detector 502 detects whether or not the process is shown in the frame image by various image recognition algorithms for each of the processes A to C. The work detector 502 generates work information D1 indicating a progress status of the work such as whether the work at each time in the work site 6 is being performed based on sequentially obtained detection results, and stores the work information D1 in the storage 51.

The anomaly detector 503 detects an anomaly period in which the anomaly state occurs in the work performed by the worker W1 or the like based on the work information D1 and the normal state information D2 acquired from the storage 51, for example. For example, the anomaly period is detected as a period in which the progress status of the work by the worker W1 or the like deviates from the reference in the normal state information D2. Based on the detected anomaly period and the process information D3, the anomaly detector 503 outputs anomaly information to the moving image extractor 504, the anomaly information associating the anomaly period, a process performed in the anomaly period, and the camera 2 corresponding to the performed process with each other.

Based on the anomaly information from the anomaly detector 503 and the moving image data D0 and the process information D3 in the storage 51, the moving image extractor 504 generates an extracted moving image obtained by extracting moving images captured by some of the cameras 2 from the moving images captured by the respective cameras 2 in a predetermined analysis period, according to the detected anomaly period and the like. The analysis period is a period to be analyzed using the camera 2 in the work analysis system 1, and is set in advance to, for example, one day. The analysis period may be any period designated by an input from the user via the user interface 53, and may be 1 hour, 1 week, or 1 month.

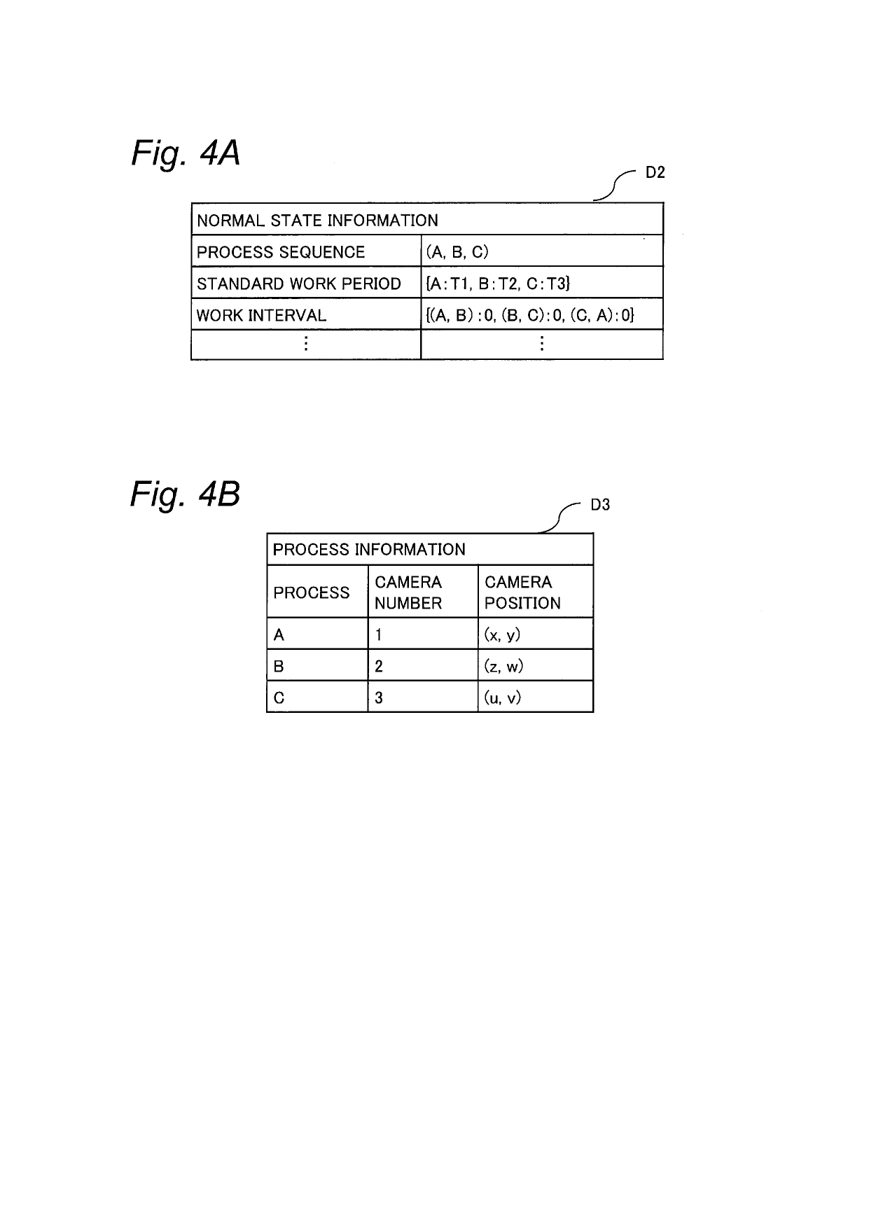

1-4. Normal state information and process information FIG. 4 is a diagram for explaining information stored in the storage 51 of the work analysis device 5. FIG. 4A illustrates normal state information D2 for processes A to C. FIG. 4B illustrates process information D3 on the processes A to C.

For example, as illustrated in FIG. 4A, the normal state information D2 includes items of “process sequence”, “standard work period”, and “work interval”. The normal state information D2 includes, for each item, a reference value set according to a work plan in the work site 6 or a work tendency of the worker W1 and/or the like, for example. The value of the normal state information D2 may be set for each worker such as the worker W1.

The process sequence indicates a sequential order in which the processes A to C are performed in the work site 6. In the example of FIG. 1, the work is repeatedly performed in the order of processes A, B, and C. The standard work period indicates a period required for each of the processes A to C by the worker W1 or the like, and is calculated by averaging periods measured a plurality of times in advance, for example. In the normal state information D2 of FIG. 4A, standard work periods T1, T2, and T3 are set in the processes A, B, and C, respectively. The work interval indicates a period from the end of the preceding process to the start of the next process for each of two processes whose the process sequences are adjacent in the processes A to C, and is set to “0” in an example of FIG. 4A.

For example, as illustrated in FIG. 4B, the process information D3 includes a “camera number” identifying each camera 2 and a “camera position” indicating a position where each camera 2 is installed in the work site 6. The process information D3 manages each of the processes A to C associating with a camera 2 that captures an image of a process area of the respective processes A to C among the cameras 2-1 to 2-3, the process area indicating an area where each of the processes A to C is performed in the work site 6. In the example of FIG. 1, the process information D3 stores camera numbers indicating the corresponding cameras 2-1, 2-2, and 2-3 for the processes A, B, and C, respectively.

In the present embodiment, for example, each camera 2 has an angle of view according to an image capturing range in the work site 6 set for each camera 2, and the image capturing range of each camera 2 corresponds to the camera position of the process information D3. In addition, the process information D3 of the present embodiment manages information related to each process in the order of the processes A, B, and C according to the process sequence in the normal state information D2, for example. Such information may be used for determination of the process sequence in processing to be described later, for example.

### 2. Operation

Operations of the work analysis system 1 and the work analysis device 5 configured as described above will be described below.

### 2-1. Overview of operation

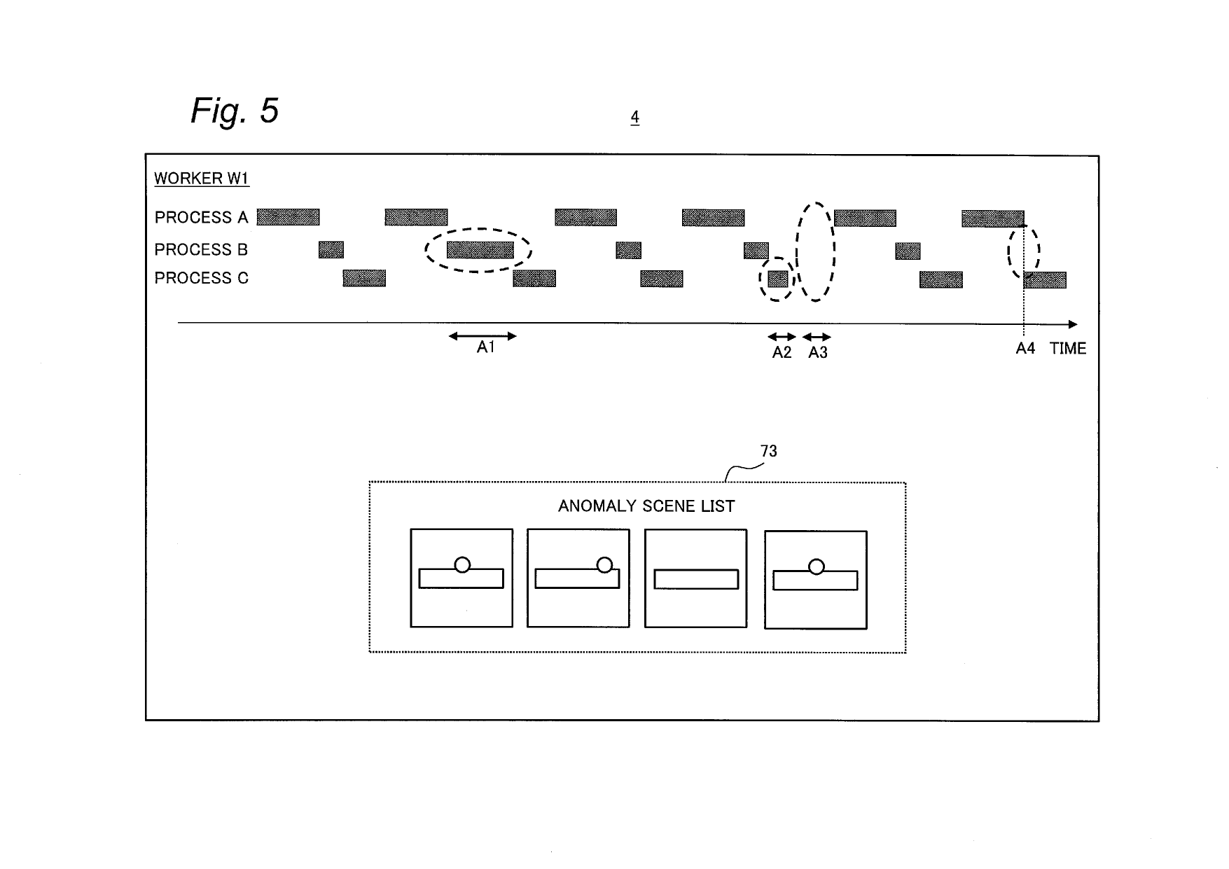

An overview of an operation of the work analysis system 1 in the present embodiment will be described with reference to FIG. 5. FIG. 5 is a diagram for explaining the overview of the operation of the work analysis system 1 in the present embodiment.

FIG. 5 illustrates an example in which the work for the processes A to C performed by the worker W1 in the work site 6 is detected by the work analysis device 5 of the present system 1 illustrated in FIG. 1. The work analysis device 5 accumulates moving image data D0 of the work site 6 captured by each camera 2 over the analysis period such as one day in the storage 51a. The work analysis device 5 outputs a work time graph visualizing the work period based on a work detection result by image recognition processing on the accumulated moving image data D0, for example, and displays the work time graph on the monitor 4. As illustrated in FIG. 5, the work time graph indicates the work period of the worker W1 in time series for each of the processes A to C.

The present system 1 further detects the anomaly period in the work of the worker W1, and displays each of the anomaly periods A1 to A4 in the work time graph, for example, as illustrated in FIG. 5. In the example of FIG. 5, in the work of the worker W1 detected for each of the processes A to C, the anomaly period A1 corresponds to an anomaly state in which the work period is longer than the standard work period of the process B, and the anomaly period A2 corresponds to an anomaly state in which the work period is shorter than the standard work period of the process C. In addition, the anomaly period A3 corresponds to an anomaly state in which no work is performed between the process C and the next process A, and the anomaly period A4 corresponds to an anomaly state in which the process B subsequent to the process A is not performed, omitting the work for the process.

For example, the present system 1 causes the monitor 4 to display the moving image from the camera 2 corresponding to each of the anomaly periods A1 to A4 in the moving image display area 73. In such processing, the work analysis device 5 extracts moving images captured by a part of cameras 2 from moving images captured by the plurality of cameras 2 according to the respective anomaly periods A1 to A4. According to such display, for example, the user 3 can check the moving image displayed in the moving image display area 73 for each of the anomaly periods A1 to A4 and analyze details such as a factor of the anomaly state in the work of the worker W1. In addition, in the work analysis device 5, for example, the extracted moving images can be displayed for each of the anomaly periods A1 to A4 rather than displaying all the moving images from each camera 2, and processing load in the work analysis system 1 can be reduced.

Regarding the process in the anomaly period, a possible case involves a factor of the anomaly state in the anomaly period in surrounding processes of such anomaly process, the surrounding processes being peripheral to the anomaly process in terms of the process sequence or the positional relationship in which each process is performed in the work site 6, for example.

To address such possible case described above, among moving images captured by the respective cameras 2, the work analysis system 1 of the present embodiment extracts moving image captured by a part of the cameras 2 associated with processes respectively performed in periods before and after the anomaly period in addition to a process performed in each of the anomaly periods A1 to A4 among the processes A to C, for example. According to the present system 1, for example, the user 3 can conduct analysis by confirming the extracted moving image for each of the anomaly periods A1 to A4, and can easily analyze the work including the processes performed in the work site 6 from the moving image obtained by image capturing of the work site 6 by each camera 2.

### 2-2. Operation of work analysis device

The operation of the work analysis device 5 in the work analysis system 1 will be described below.

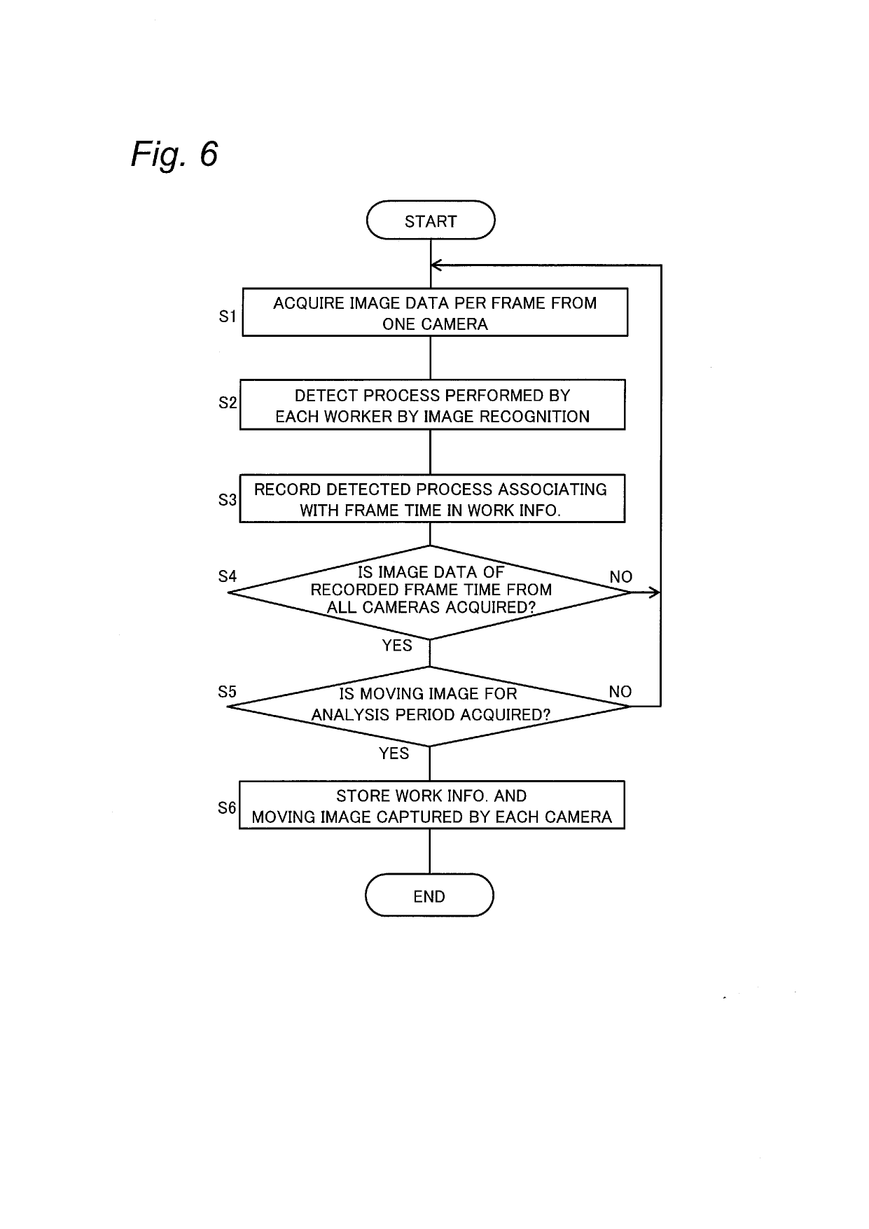

2-2-1. Acquisition of moving image and detection of work An operation of work detection in which the work analysis device 5 acquires the moving image data D0 of the work site 6 from the camera 2 and detects work for each of the processes A to C performed in the work site 6 by image recognition processing will be described with reference to FIG. 6.

FIG. 6 is a flowchart illustrating operations of the moving image obtainer 501 and the work detector 502 in the work analysis device 5 of the present embodiment. The processing of this flowchart is performed by the controller 50 of the work analysis device 5 functioning as the moving image obtainer 501 and the work detector 502 illustrated in FIG. 3. The processing of this flowchart is repeatedly performed for each analysis period, for example.

First, as the moving image obtainer 501, the controller 50 acquires image data for each frame of the moving image captured by the camera 2 from one camera 2 via the device I/F 54 (S1). For example, in the work analysis system 1 of FIG. 1, first, image data is acquired from the camera 2-1.

Next, the controller 50 detects, as the work detector 502, a process of work performed by each worker such as the worker W1 appearing in the image, by image recognition processing on the frame image based on the acquired image data (S2). For example, the controller 50 detects the process A in the image data from the camera 2-1. The controller 50 may switch between the processes A to C for detection depending on from which of the cameras 2-1 to 2-3 the image data is acquired.

The controller 50 associates the captured time at which the frame image is captured, as a frame time, with the detected process of the work, and records the detected process associated with the frame time in the work information D1 for each worker (S3). The work information D1 is held in, for example, the temporary storage 51b. For example, when the process for detection is not detected in step S2, the frame time and the information indicating such undetected result may be associated with each other and recorded in the work information D1.

The controller 50 refers to the process information D3 stored in the storage 51a, and determines whether or not image data of a frame at the same frame time as the frame acquired in step S1 is acquired for all the cameras 2 in the work site 6, for example (S4).

In a case where image data of the same frame time is not acquired for all the cameras 2 (NO in S4), the controller 50 repeats the processing of steps S1 to S3. In the example of FIG. 1, steps S1 to S3 are repeated until image data at the same frame time is acquired for all of the cameras 2-1 to 2-3 (NO in S4).

When the image data of the same frame time is acquired for all the cameras 2 (YES in S4), the controller 50 determines whether the image data for each frame in the analysis period is acquired, that is, whether the acquisition of the moving image captured by each camera 2 in the analysis period is completed (S5). The controller 50 performs the determination in step S5 based on the length of the analysis period set in advance, the frame rate of the moving image, and the like, for example.

When the acquisition of the moving image in the analysis period is not completed (NO in S5), the controller 50 repeats the processing in and after step S1.

When the acquisition of the moving image in the analysis period is completed (YES in S5), the controller 50 stores the work information D1 recorded in step S3 and the moving image for each camera 2 in which the image data is acquired for each frame for each camera 2 in the storage 51a (S6). Thereafter, the controller 50 ends the processing of this flowchart.

According to the above processing, the moving image for each camera 2 in the analysis period is acquired (S1, S4, S5), and the work information D1 for each time and the moving image for each camera 2 are stored based on the detection results of the processes A to C of the work in each frame image of the moving image (S2, S3, S6). As a result, the moving image used for analysis in the work analysis system 1 is acquired, and the time-series work information D1 in which detection of the processes A to C are performed for each frame of the moving image is obtained.

The example in which the process of the work performed by the worker W1 is detected by the image recognition processing is described above. When a plurality of workers perform work, the workers may be distinguished and detected by image recognition processing, or the workers may be identified according to positions in the work site 6. Furthermore, for example, each worker may be identified based on personal authentication information obtained when the worker enters the work site 6.

Furthermore, the operation of work detection is not limited to the above example, and for example, after acquiring the moving image data in the analysis period from the camera 2-1 and generating the work information D1 by the image recognition processing for each frame image for the camera 2-1, similar processing may be performed for the cameras 2-2 and 2-3. In step S1, the moving image obtainer 501 may acquire moving image data received from the camera 2 in advance and stored in the storage 51a, for example.

2-2-2. Detection of anomaly period and generation of extracted moving image An operation in which the work analysis device 5 detects an anomaly period in the work after the operation of the work detection as described above and generates an extracted moving image from the moving image data D0 according to the detected anomaly period will be described with reference to FIGS. 3 and 7 to 9.

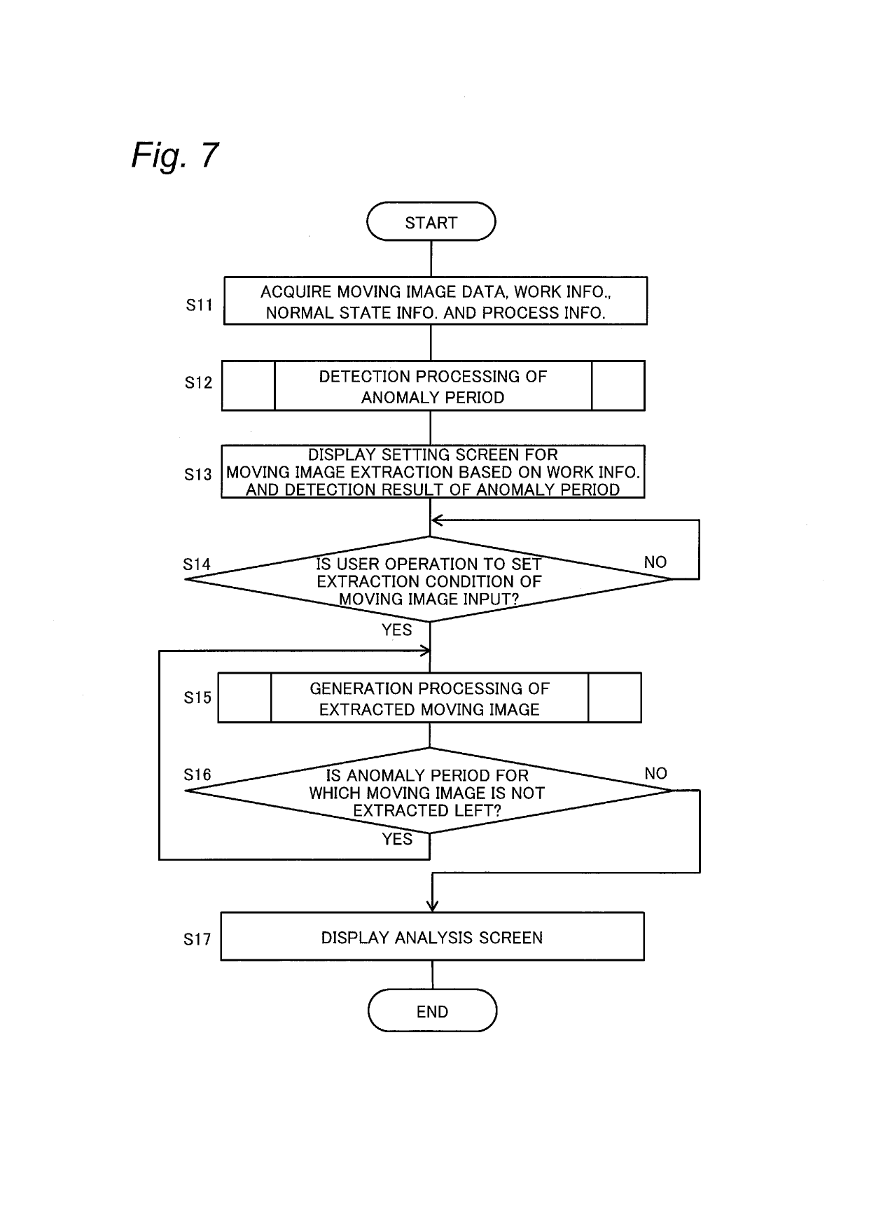

FIG. 7 is a flowchart illustrating operations of the anomaly detector 503 and the moving image extractor 504 in the work analysis device 5 of the present embodiment. The processing of this flowchart is performed by the controller 50 of the work analysis device 5 functioning as the anomaly detector 503 and the moving image extractor 504 illustrated in FIG. 3. The processing of this flowchart is started, for example, in a state in which the moving image data D0 and the work information D1 obtained by the processing illustrated in the flowchart of FIG. 6 are stored in the storage 51a in addition to the normal state information D2 and the process information D3.

First, the controller 50 acquires the moving image data D0 and the work information D1 stored in step S6 of FIG. 6, and the stored normal state information D2 and process information D3 from the storage 51a (S11).

Next, as the anomaly detector 503, the controller 50 detects an anomaly period in the work of the worker W1 or the like based on the work information D1, the normal state information D2, and the process information D3 (S12). By such detection processing of the anomaly period (S12), for example, anomaly periods A1 to A4 and the like illustrated in FIG. 5 are detected. The controller 50 holds anomaly information including, for example, the detected anomaly periods A1 to A4 in the temporary storage 51b. Details of the detection processing of the anomaly period (S12) will be described later.

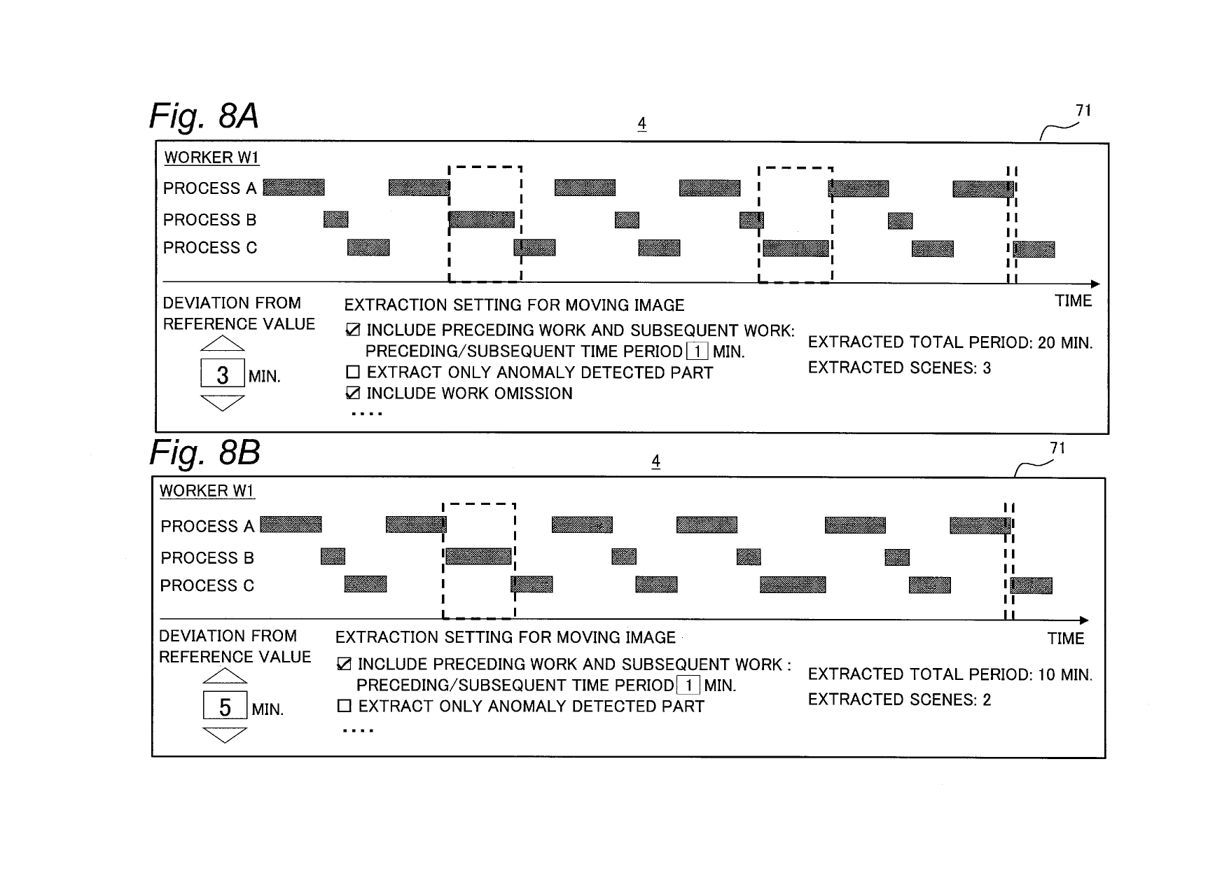

Based on the work information D1 and the anomaly information obtained in step S12, the controller 50 causes, via the output I/F 55, the monitor 4 to display a setting screen for user setting regarding generation of the extracted moving image, for example (S13). A display example of such a setting screen is illustrated in FIG. 8.

FIG. 8 is a diagram for explaining a setting screen in the work analysis system 1. FIG. 8A illustrates a setting screen 71 displayed on the monitor 4 in step S13 of FIG. 7. The setting screen 71 displays, for example, setting items and the like for setting an extraction condition in generating the extracted moving image in addition to the work time graph of the worker W1 similar to FIG. 5. The extraction condition includes, for example, a threshold as to whether or not the work period is detected as the anomaly period indicating a difference (also referred to as “deviation”.) from a predetermined reference value the work period of each of the processes A to C of the worker W1 or an interval between two successive processes among the processes A to C and . In an example of FIG. 8A, the threshold is set to “3 minutes”.

Furthermore, the extraction condition in the example of FIG. 8A includes conditions such as whether or not to generate the extracted moving image including periods before and after the anomaly period, lengths of the respective periods in a case where the periods before and after the anomaly period are included, and whether or not to include work omission in the anomaly period, the work omission indicating a period in which the process included in the work is not performed. In the example of FIG. 8A, the setting screen 71 indicates that a moving image for a total period of “20 minutes” is extracted from the moving image data D0 in the setting being displayed, and the number of scenes showing respective anomaly periods is “3”. For example, an initial value stored in the storage 51a may be set as the extraction condition.

The controller 50 determines whether or not a user operation setting the extraction condition of moving images is input via the user interface 53 in a state where the setting screen 71 as illustrated in FIG. 8A is displayed, for example (S14). When the user operation is not input (NO in S14), the controller 50 repeats the determination in step S14. For example, in a case where the user operation is not input for a predetermined period, the process may proceed to step S15.

FIG. 8B illustrates an example in which the user operation setting a moving image extraction condition is input (YES in S14) from the example of FIG. 8A, and the extraction condition is changed. In the example of FIG. 8B, the deviation from the reference value is changed from “3 minutes” to “5 minutes” from the example of FIG. 8A. With this change, on the setting screen 71 in FIG. 8B, the total period of the moving images extracted from the moving image data D0 is “10 minutes”, and the number of scenes showing anomaly periods is “2”, which is reduced from the example in FIG. 8A.

When the user operation is input (YES in S14), the controller 50, as the moving image extractor 504, generates an extracted moving image for one anomaly period in the anomaly information based on the moving image data D0, the process information D3, and the anomaly information, for example (S15). In such generation processing of the extracted moving image (S15), the controller 50 generates the extracted moving image for each anomaly period according to the extraction condition set by the user operation in step S14, for example. The generation processing of the extracted moving image (S15) will be described later in detail.

The controller 50 determines whether or not an anomaly period is left without applying the generation processing of the extracted moving image (S15), as the anomaly period for which a moving image is not yet extracted, among the anomaly periods detected in step S12 included in the anomaly information (S16). For example, the controller 50 may manage the anomaly periods by associating a flag or the like indicating whether or not the moving image is extracted for each of the anomaly periods A1 to A4, the flag being held in the temporary storage 51b.

When the anomaly period with a moving image not extracted is left (YES in S16), the controller 50 executes the generation processing of the extracted moving image (S15) for the anomaly period.

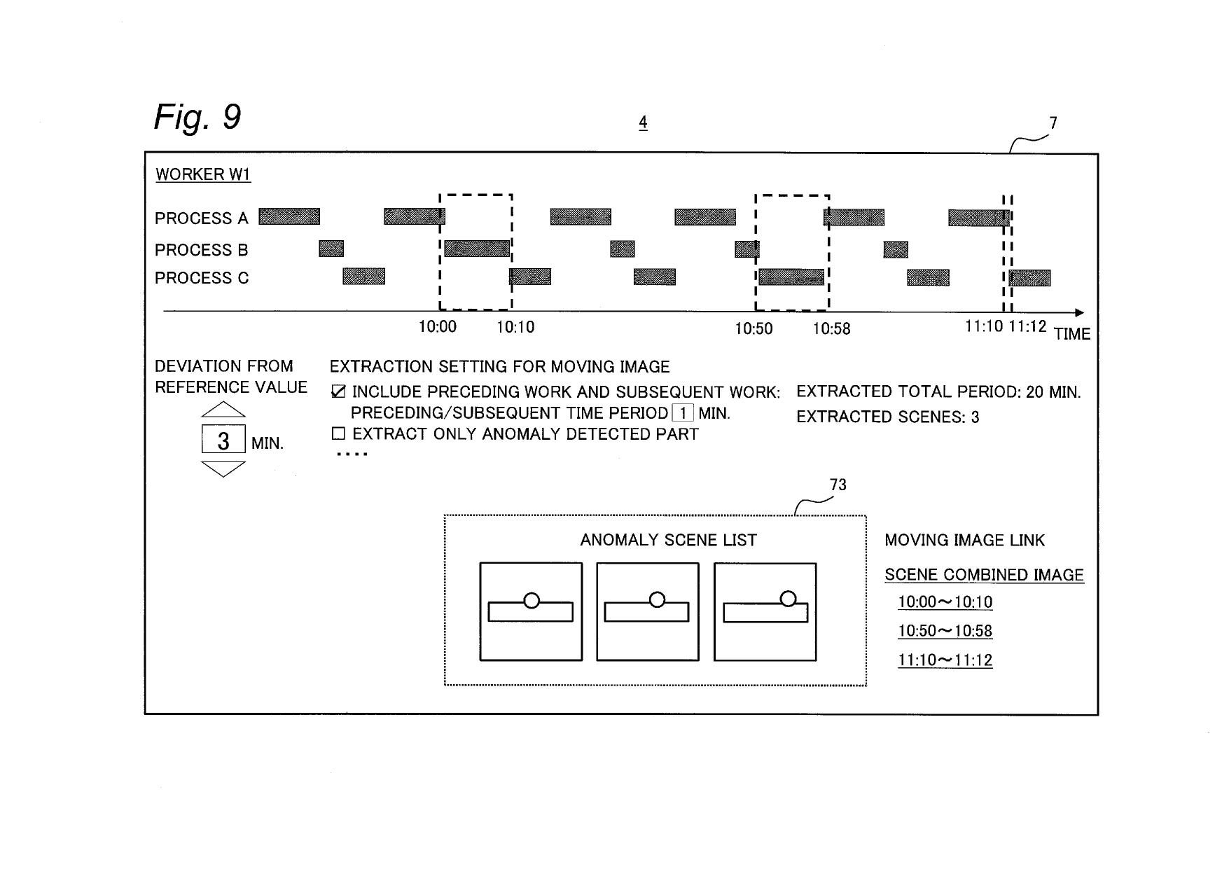

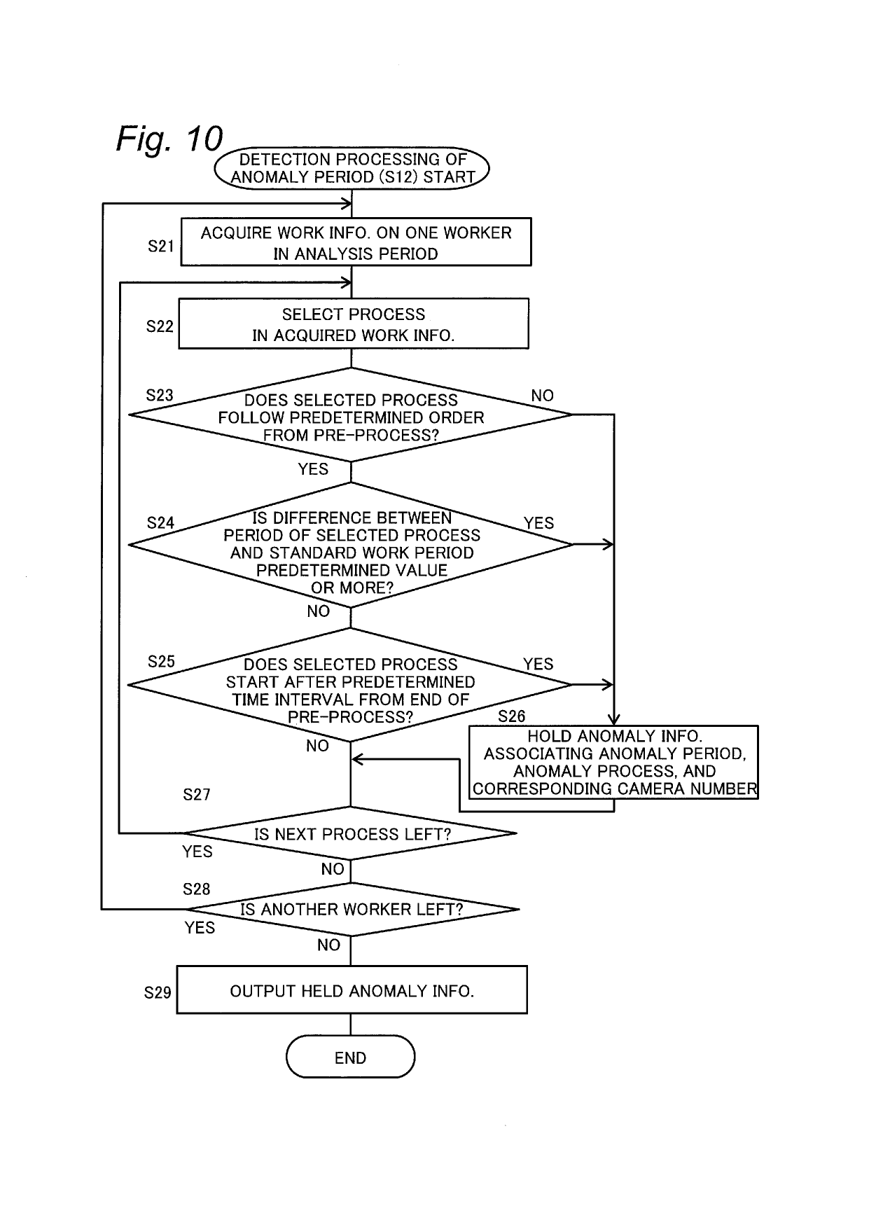

When the anomaly period with the moving image not extracted is not left (NO in S16), the controller 50 displays the analysis screen on the monitor 4 via the output I/F 55 based on the work information D1, the anomaly information, the moving image data of the generated extracted moving image, and the like (S17). FIG. 9 is a diagram for explaining an analysis screen 7 in the work analysis system 1.

The analysis screen 7 displays, for example, a moving image display area 73 and a link for displaying the extracted moving image and the like on the monitor 4 in addition to display contents similar to those of the setting screen 71 in FIG. 8A. The moving image display area 73 displays a list of scenes showing the extracted moving image in each anomaly period with thumbnail images or the like. In such a list display, the extracted moving image may be reproduced on the monitor 4 in response to, for example, a click operation of the corresponding thumbnail image by the user interface 53 such as a mouse. The analysis screen 7 also displays a link for displaying a moving image obtained by combining the extracted moving images of the respective scenes. The controller 50 may generate such a scene combined image by combining the extracted moving images in chronological order, for example, after the generation processing of the extracted moving image (S15).

According to the analysis screen 7, the user 3 of the present system 1 can analyze the extracted moving image corresponding to each anomaly state or analyze the scene combined image in order to review, for example, the detected anomaly period and the like.

After displaying the analysis screen 7 (S17), the controller 50 ends the processing of this flowchart.

According to the above processing, the anomaly period in the work is detected based on the work information D1 and the like (S12), and moving images from cameras 2 associated with the process performed in each anomaly period, the preceding and subsequent processes, and the like are extracted among the moving images from the plurality of cameras 2 (S15). Therefore, for example, the user 3 can confirm the extracted moving image for the anomaly state that occurs in each anomaly period, and it is possible to easily analyze the work performed in the work site 6 from the moving image obtained by image capturing of the work site 6 by each camera 2.

Furthermore, in the above processing, the extracted moving image is generated according to the extraction condition set by the user (S15) according to the user operation setting the extraction condition of moving images (S14). Therefore, the user 3 can further easily analyze the work from the extracted moving image generated under the desired extraction condition.

Furthermore, for example, the analysis screen 7 is displayed on the monitor 4 or the like to present the generated extracted moving image and the like to the user 3 (S17). As a result, for example, the user 3 can confirm each extracted moving image and the like on the analysis screen 7.

2-2-2-1. Detection processing of anomaly period Details of the detection processing of the anomaly period in step S12 of FIG. 7 will be described with reference to FIG. 10.

FIG. 10 is a flowchart illustrating the detection processing of the anomaly period (S12) in the work analysis device 5 of the present embodiment. The processing of this flowchart is started in a state where, for example, the work information D1, the normal state information D2, and the process information D3 acquired in step S11 of FIG. 7 are held in the temporary storage 51b or the like. Each processing of this flowchart is performed by the controller 50 functioning as the anomaly detector 503 illustrated in FIG. 3, for example.

The controller 50 acquires work information on one worker in the analysis period from the work information D1 recorded for each worker, for example, in an internal memory or the like (S21). For example, first, work information on the worker W1 is acquired.

The controller 50 selects one process among processes sequentially recorded in time series in the acquired work information (S22). For example, first, a process corresponding to the earliest time in the work information is selected.

Based on the normal state information D2, the controller 50 determines whether or not the process selected in the work information is performed in accordance with a predetermined process sequence from a preceding process as a pre-process performed immediately before the process (S23). Specifically, the controller 50 determines whether or not the order of the selected process and the preprocess matches the process sequence in the normal state information D2 (S23). In the example of the anomaly period A4 of FIG. 5, when the process C is selected in step 22, it is determined that the process C is in an anomaly state not following the normal order from the pre-process A in the work information (NO in S23).

When the selected process does not follow the predetermined process sequence (NO in S23), the controller 50 holds, in the temporary storage 51b, the anomaly period in which the anomaly state occurs, the process performed in the anomaly period, and the anomaly information associated with the camera number of the camera 2 corresponding to the process (S26). For example, the anomaly period may be determined according to the anomaly state, and when a sequential order of performed processes in the work information is different from the process sequence in the normal state information D2, that is, when the work is in the anomaly state with the work omission (NO in S23), the anomaly period may be determined as the period of the process with thed work omission based on the work information.

For example, in the anomaly period A4 in FIG. 5, the period of the process B performed between the processes A and C in the process sequence in the normal state information D2 is determined to be the anomaly period, and is recorded in the anomaly information to include the start time and the end time of the period. In this case, the controller 50 refers to, for example, the normal state information D2 and identifies a process (also referred to as an “anomaly process”) performed during the anomaly period as the process B. In addition, the controller 50 identifies the camera number of the camera 2 corresponding to the anomaly process based on the process information D3. For example, in the process information D3 of FIG. 4B, the camera 2-2 with the camera number “2” corresponds to the anomaly process B.

After holding the anomaly information in the temporary storage 51b (S26), the controller 50 determines whether a process subsequent to the selected process is left in the work information acquired in step S21 (S27). When the work information includes the next process (YES in S27), the controller 50 returns to step S22, selects the next process, and repeats the processing in and after step S23.

When the selected process is performed according to the normal process sequence from the pre-process (YES in S23), the controller 50 determines whether or not a difference between the period of the selected process in the work information and the standard work period of the process in the normal state information D2 is a predetermined value or more (S24). The predetermined value is set to, for example, one minute or the like from a viewpoint of detecting the anomaly period such as the anomaly periods A1 and A2 in FIG. 5, in which the work period is too long or too short as compared with the standard work period. The predetermined value may vary depending on, for example, a type of the pre-process and the selected process, and may be 30 seconds or 10 minutes. In addition, the predetermined value may be a different value depending on whether the anomaly period in which the work period is longer than the standard work period is detected or the anomaly period in which the work period is shorter than the standard work period is detected. The predetermined value may be a value different from the user setting in step S14 in FIG. 7.

When the difference between the period of the selected process and the standard work period is the predetermined value or more (YES in S24), the controller 50 holds the anomaly period or the like in the temporary storage 51b as anomaly information (S26). In the example of the anomaly period A1, the anomaly information is held to include the period of the process B in the work information as the anomaly period and the process B as the anomaly process.

When the difference between the period of the selected process and the standard work period is not the predetermined value or more (NO in S24), the controller 50 determines whether or not an interval between the start time of the selected process and the end time of the pre-process in the work information is the predetermined interval or more (S25). The predetermined interval is, for example, a work interval in the normal state information D2. For example, as in the anomaly period A3 in FIG. 5, when no work is performed between processes that are performed consecutively in the normal state information D2, it is determined that the interval between the processes is equal to or more than the predetermined interval (YES in S25).

When the interval between the start time of the selected process and the end time of the pre-process is the predetermined interval or more (YES in S25), the controller 50 proceeds to step S26 and holds the anomaly information in the temporary storage 51b. In the example of the anomaly period A3 in FIG. 5, when the process A is selected, in a case where the interval between the start time of the process A and the end time of the pre-process C is the predetermined interval or more (YES in S25), the anomaly information is held to include the interval as the anomaly period. In this case, the anomaly process may be determined to be the selected process A, or may be determined to be the pre-process C, for example.

When the interval between the start time of the selected process and the end time of the pre-process is not equal to or longer than the predetermined interval (NO in S25), the controller 50 determines whether a next process is left in the work information (S27), similarly to after the anomaly state is held (S26).

When the last process in the work information is selected and the next process is not left (NO in S27), the controller 50 determines whether or not work information on one or more workers different from the worker of the acquired work information in step S21 is recorded in the work information D1 for all the workers (S28).

When the work information D1 includes the work information on the one or more workers (YES in S28), the controller 50 returns to step S21, acquires the work information of one worker among the one or more workers, and repeats the processing in and after step S22.

On the other hand, when the work information D1 does not include the work information of another worker (NO in S28), the controller 50 as the anomaly detector 503 outputs the anomaly information held in the temporary storage 51b to, for example, the moving image extractor 504 (S29).

After outputting the anomaly information (S29), the controller 50 ends the processing of this flowchart.

According to the above processing, it is determined whether or not the process detected as the work of each worker follows the predetermined process sequence based on the work information D1 and the normal state information D2 (S23). In addition, it is determined whether or not the difference between the detected period of each process and the standard work period is a predetermined value or more (S24), and whether or not the interval between processes is a predetermined interval or more (S25). When the detected process does not follow the predetermined process sequence (NO in S23), when the difference between the period of each process and the standard work period is greater than or equal to a predetermined value (YES in S24), or when the interval between the processes is greater than or equal to a predetermined interval (YES in S25), anomaly information is held (S26). The anomaly information includes the anomaly period, the anomaly process, and the camera number corresponding to the anomaly process in association with one another.

According to the above processing, the anomaly periods A1 to A4 and the like as illustrated in FIG. 5 are detected, and the anomaly process performed in each anomaly period and the camera 2 corresponding to each anomaly process among the cameras 2 can be managed in association with each other by the anomaly information.

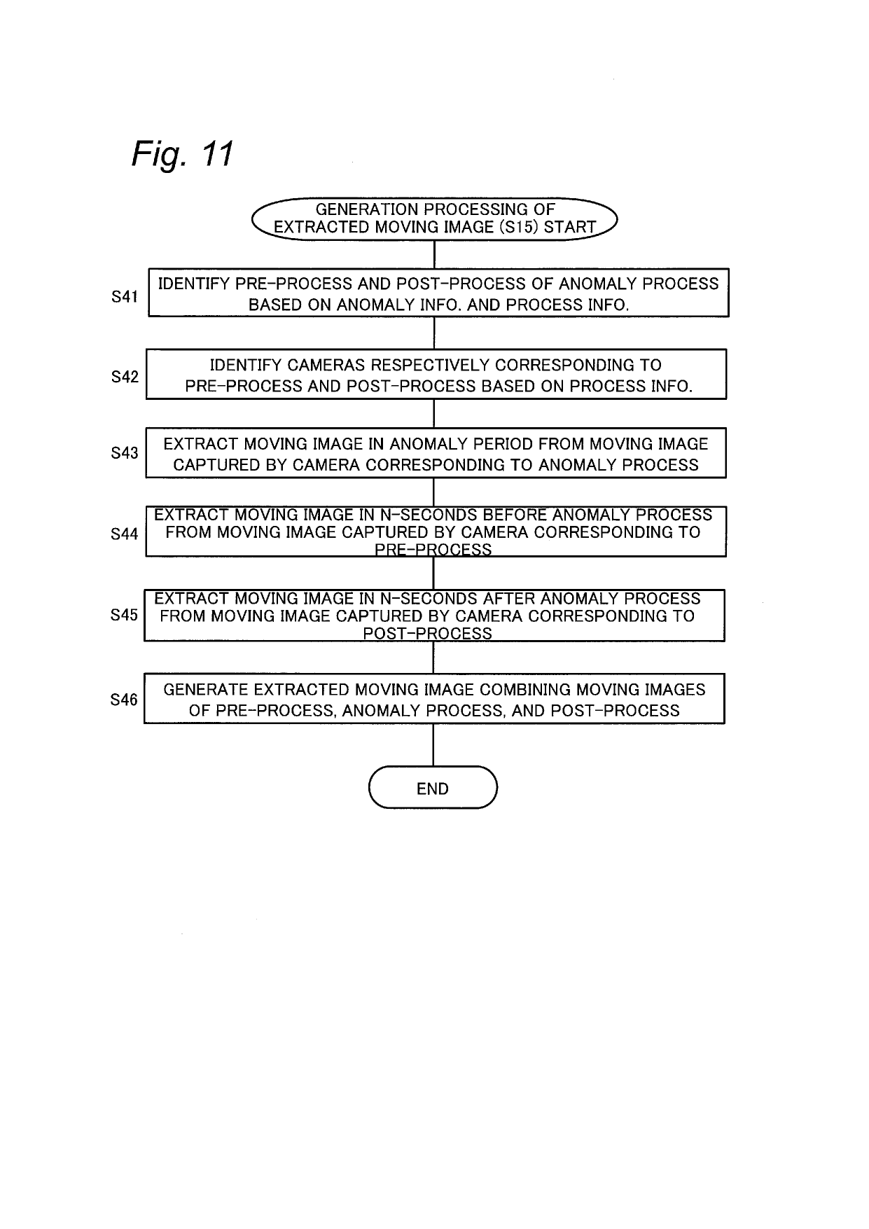

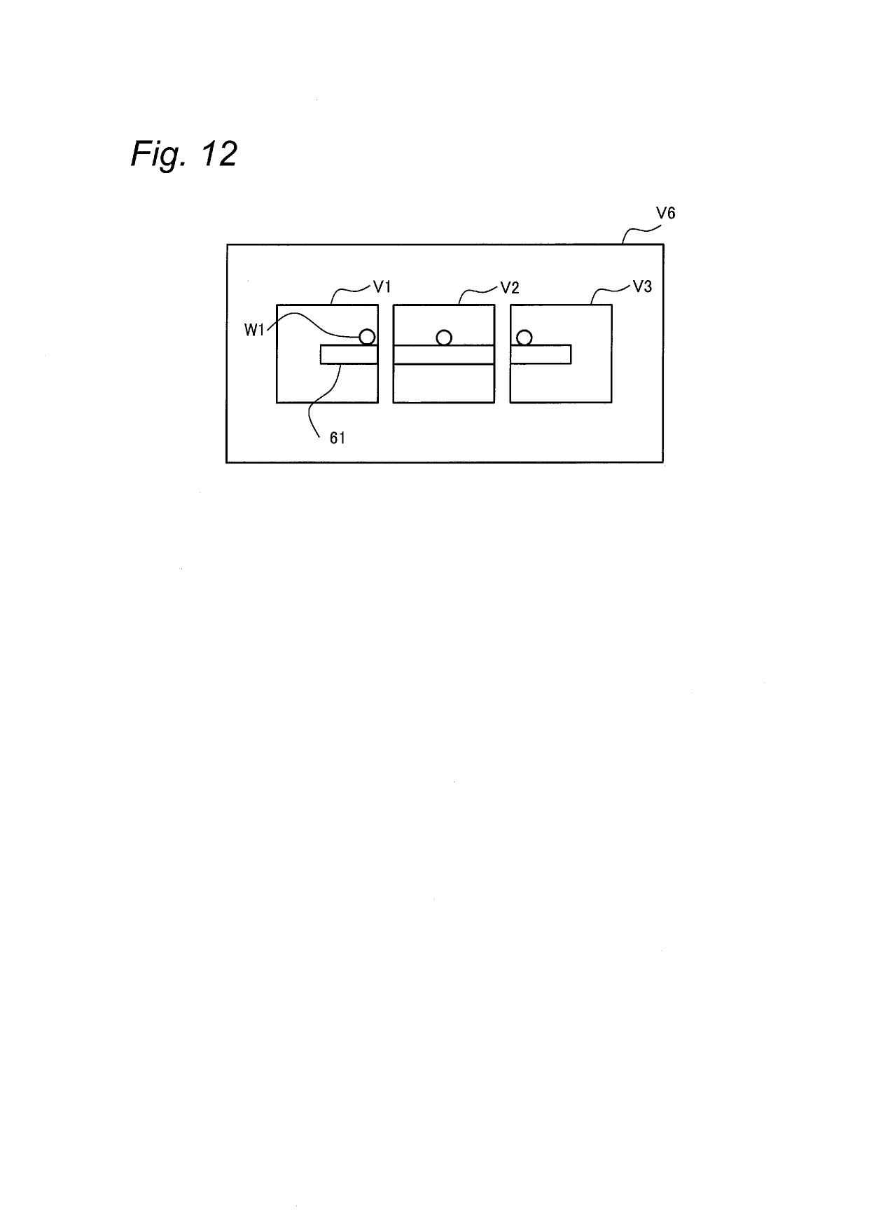

2-2-2-2. Generation processing of extracted moving image Details of the generation processing of the extracted moving image in step S15 of FIG. 7 using the anomaly information obtained by the above-described detection processing of the anomaly period (S12) will be described with reference to FIGS. 11 and 12.

FIG. 11 is a flowchart illustrating the generation processing of the extracted moving image (S15) in the work analysis device 5 of the present embodiment. The processing of this flowchart is performed by the controller 50 functioning as the moving image extractor 504 in FIG. 3 for each detected anomaly period based on the anomaly information output from the anomaly detector 503, for example. The processing of this flowchart is performed with reference to, from the storage 51, the moving image data D0 and the process information D3 acquired in step S11 of FIG. 7 and the anomaly information held in step S12, for example. FIG. 12 is a diagram for explaining the generation processing of the extracted moving image (S15) of the present embodiment.

First, the controller 50 identifies a pre-process performed immediately before the anomaly process (i.e., a pre-process) and a subsequent process performed immediately after the anomaly process, as a post-process, in the work site 6 based on the anomaly information and the process information D3, for example, (S41). For example, in the anomaly period A1 of FIG. 5, since the anomaly process is the process B, the process A is identified as the pre-process and the process C is identified as the subsequent process from the order defined between the processes A to C. In addition, in the case of the work repeating the processes A to C, when the process C is the anomaly process, the process A is identified as the pre-process, and the process B is identified as the pre-process.

Next, the controller 50 identifies the camera 2 corresponding to each of the pre-pre-process and the post-process based on the process information D3 (S42). In the example of the anomaly period A1, the camera 2-1 corresponding to the pre-process A and the camera 2-3 corresponding to the post-process C are identified from the process information D3 of FIG. 4B.

Based on the anomaly information and the moving image data D0, the controller 50 extracts a moving image in the anomaly period from the moving image captured by the camera 2 corresponding to the anomaly process among the moving images captured by respective cameras 2 in the work site 6 of FIG. 1, for example (S43). FIG. 12 illustrates an extracted moving image V6 generated for the anomaly period A1. In the example of FIG. 12, the moving image V2 in the anomaly period A1 is extracted from the moving image captured by the camera 2-2 corresponding to the anomaly process B.

Based on the moving image data D0, the controller 50 extracts a moving image in a predetermined period N seconds (N is a positive number) immediately before the anomaly process from among the moving images from the cameras 2 corresponding to the pre-process among the moving images from the cameras 2 (S44). The predetermined period is set on the setting screen 71 in FIG. 8, for example, according to the user operation in step S14 in FIG. 7. In the example of FIG. 12, a moving image V1 of a predetermined period is extracted from the moving image from the camera 2-1 corresponding to the pre-process A.

Based on the moving image data D0, the controller 50 extracts a moving image in a predetermined period N seconds immediately after the anomaly process from among the moving images from the cameras 2 corresponding to the post-processes among the moving images from the cameras 2 (S45). In the example of FIG. 12, a moving image V3 of a predetermined period is extracted from the moving image from the camera 2-3 corresponding to the post-process B.

The controller 50 generates an extracted moving image by combining the moving images extracted for the pre-process, the anomaly period, and the post-process (S46). For example, the controller 50 combines the moving images in chronological order. In the example of FIG. 12, the moving image V1 in the predetermined period of the pre-process, the moving image V2 in the anomaly period A1, and the moving image V3 in the predetermined period of the post-process are sequentially combined to generate the extracted moving image V6. Furthermore, not limited to the generation of the extracted moving image V6, the controller 50 may cause the monitor 4 or the like to display the moving images V1 to V3 captured by the camera 2 corresponding to each of the pre-process, the anomaly process, and the post-process, and sequentially reproduce the moving images in time series.

After generating the extracted moving image (S46), the controller 50 stores, for example, the generated extracted moving image in the storage 51a, and ends the processing of this flowchart.

According to the above processing, the cameras 2 associated with the pre-process and the post-process of the anomaly process are identified (S41, S42), and the moving images from the cameras 2 associated with the anomaly period, the pre-process, and the post-process are extracted from the moving image captured by the respective cameras 2 (S43 to S45). Then, the respective moving images are combined to generate tje extracted moving image (S46). Therefore, it is possible to extract the moving image from the camera 2 corresponding to each of the pre-process and the post-process in addition to the anomaly process from the moving images captured by cameras 2 in the work site 6, and to generate the extracted moving image including periods before and after the anomaly period.

In the above processing, an example is described in which the moving image from the cameras 2 associated with both the pre-process and the post-process of the anomaly process is used for generating the extracted moving image (S41, S42, S44, S45). The generation of the extracted moving image is not limited to the above example, and a moving image from the camera 2 corresponding to one of the pre-process and the post-process may be used. Furthermore, in processes S44 and S45, moving images in different periods may be extracted for the pre-process and the post-process.

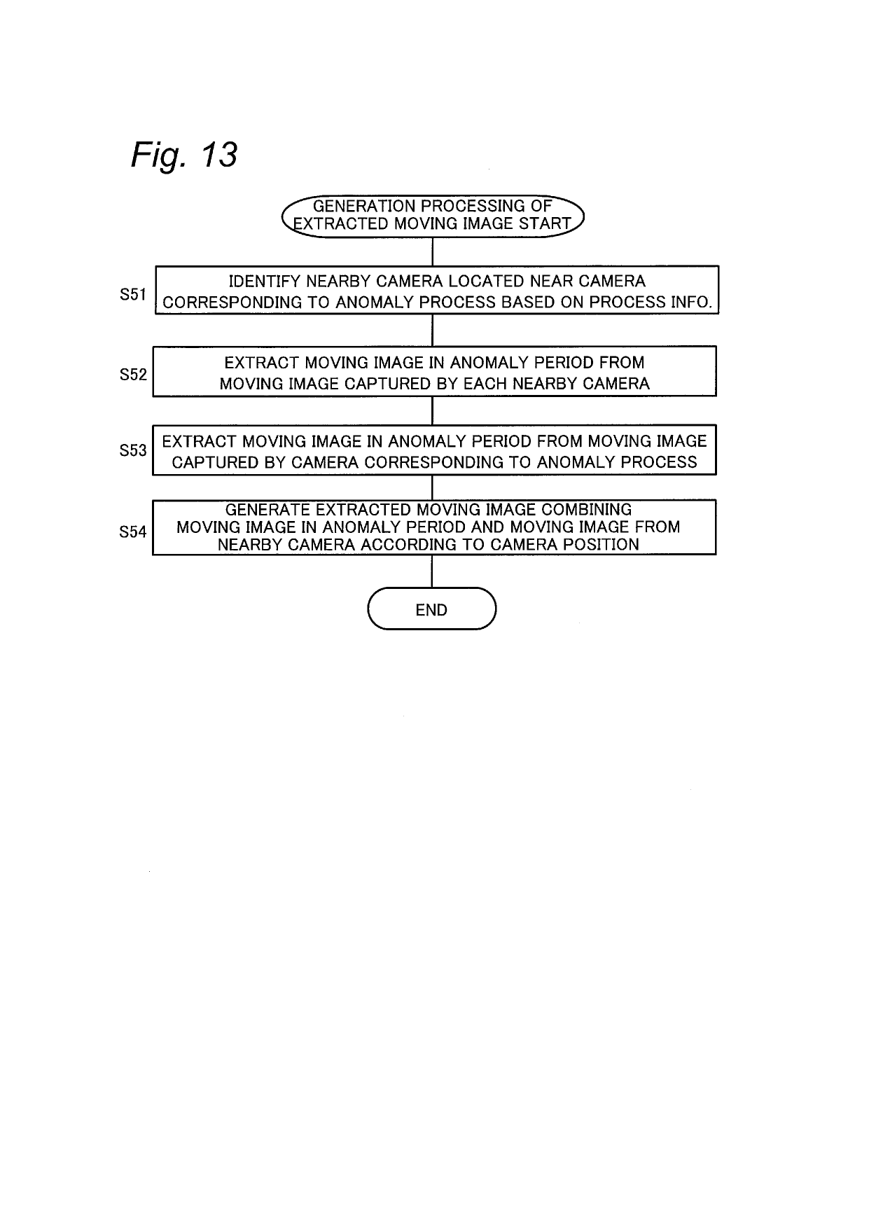

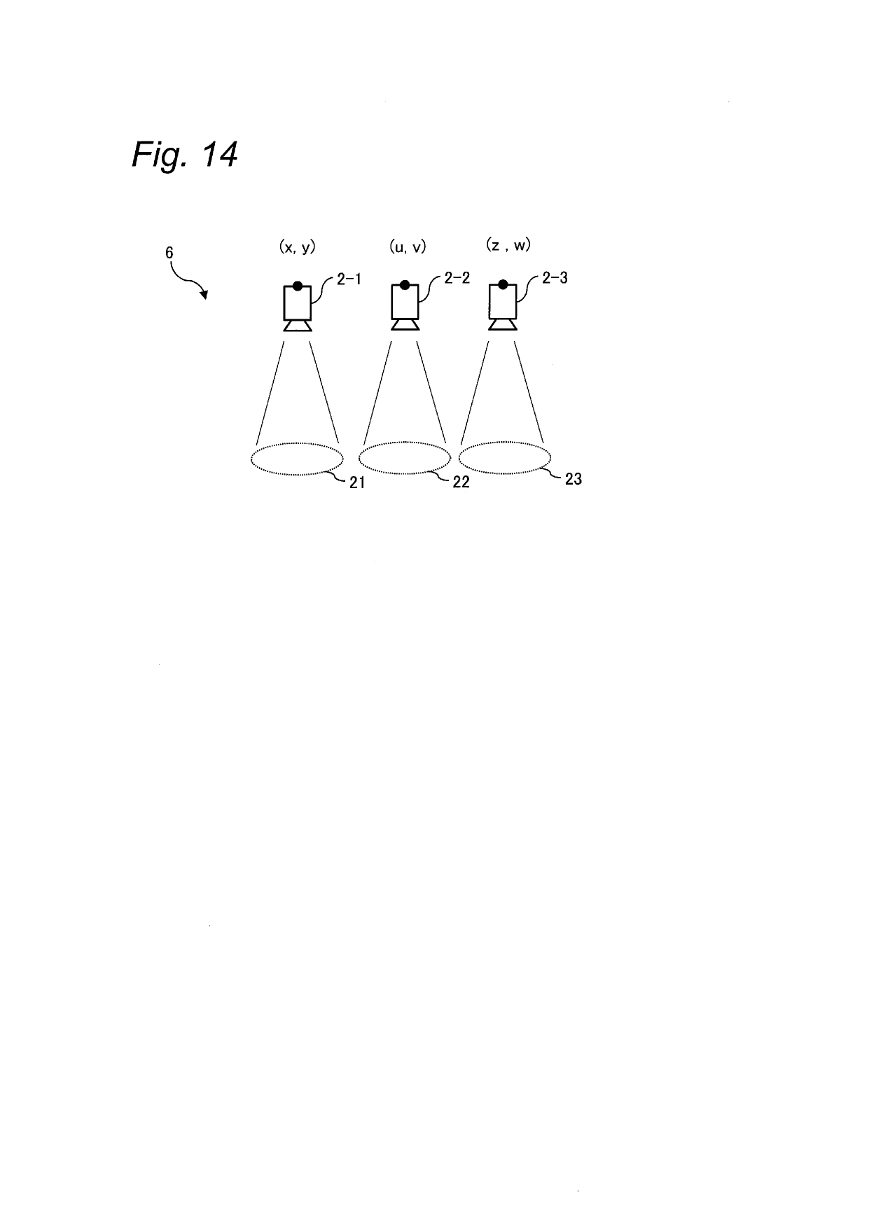

(First modification) In the first embodiment, the example in which the moving image of the process performed before and after the anomaly period is included in the extracted moving image in the generation processing of the extracted moving image (S15) is described. The extracted moving image may include, for example, a moving image of a process performed in vicinity of a position where the anomaly process is performed in the workspace 6. The first modification of the first embodiment will be described with reference to FIGS. 13 and 14.

FIG. 13 is a flowchart illustrating the generation processing of the extracted moving image in the first modification of the first embodiment. FIG. 14 is for describing the generation processing of the extracted moving image in the first modification. The processing of the flowchart in FIG. 13 is performed instead of, for example, the generation processing of the extracted moving image (S15 in FIG. 7, FIG. 11) in the first embodiment.

First, the controller 50 identifies a nearby camera located in the vicinity of the camera 2 corresponding to the anomaly process in the work site 6 among the cameras 2 based on the process information D3 (S51). In the present modification, for example, each of one or more cameras 2 of which each camera position in the process information D3 is within a predetermined range from the camera position of the camera 2 corresponding to the anomaly process is identified as the nearby camera. The predetermined range is set such that, for example, in the work site 6, image capturing ranges by the two cameras 2 are adjacent to each other. The nearby camera may be each of: cameras associated with processes before and after the anomaly process (i.e., pre-process and post process) in the work site 6; cameras associated with preceding/subsequent processes two processes away from the anomaly process; or cameras associated with further preceding/subsequent processes three processes away from the anomaly process.

FIG. 14 illustrates respective image capturing ranges 21,22, and 23 in the work site 6 for cameras 2-1, 2-2, and 2-3, each having a similar angle of view. In the present example, a positional relationship among the camera positions (x, y), (u, v), and (z, w) of the respective cameras 2-1, 2-2, and 2-3 corresponds to a positional relationship among the image capturing ranges 21, 22, and 23. For example, in a case where the anomaly process is the process B, since the camera 2-2 corresponds to the anomaly process, in step S51, the camera 2-1 and the camera 2-3 having the image capturing ranges 21 and 23 adjacent to the image capturing range 22 of the camera 2-2 are identified as the nearby cameras.

Next, the controller 50 extracts the moving image in the anomaly period from the moving image from the nearby camera, for example (S52).

The controller 50 extracts the moving image in the anomaly period from the moving image from the camera 2 corresponding to the anomaly process (S53).

The controller 50 generates the extracted moving image by combining the moving image of the anomaly process extracted in step S53 and the moving image from the nearby camera extracted in step S52 and the nearby camera corresponding to the anomaly process, based on the camera positions of the camera 2 with reference to the process information D3, for example (S54). For example, the moving images are combined to be displayed in arrangement corresponding to each camera position in the extracted moving image.

According to the above processing, the nearby camera of the camera 2 corresponding to the anomaly process is identified (S51), the moving image from the camera 2 in the anomaly period and the moving image from the nearby camera are extracted (S52, S53), and the extracted moving image is generated by combining the moving images (S54). According to such an extracted moving image including a moving image from the nearby camera, for example, even in a case where there is a factor of the anomaly state in a process around a position where an anomaly process is performed in the work site 6, the user 3 can easily analyze the work.

### (Second modification)

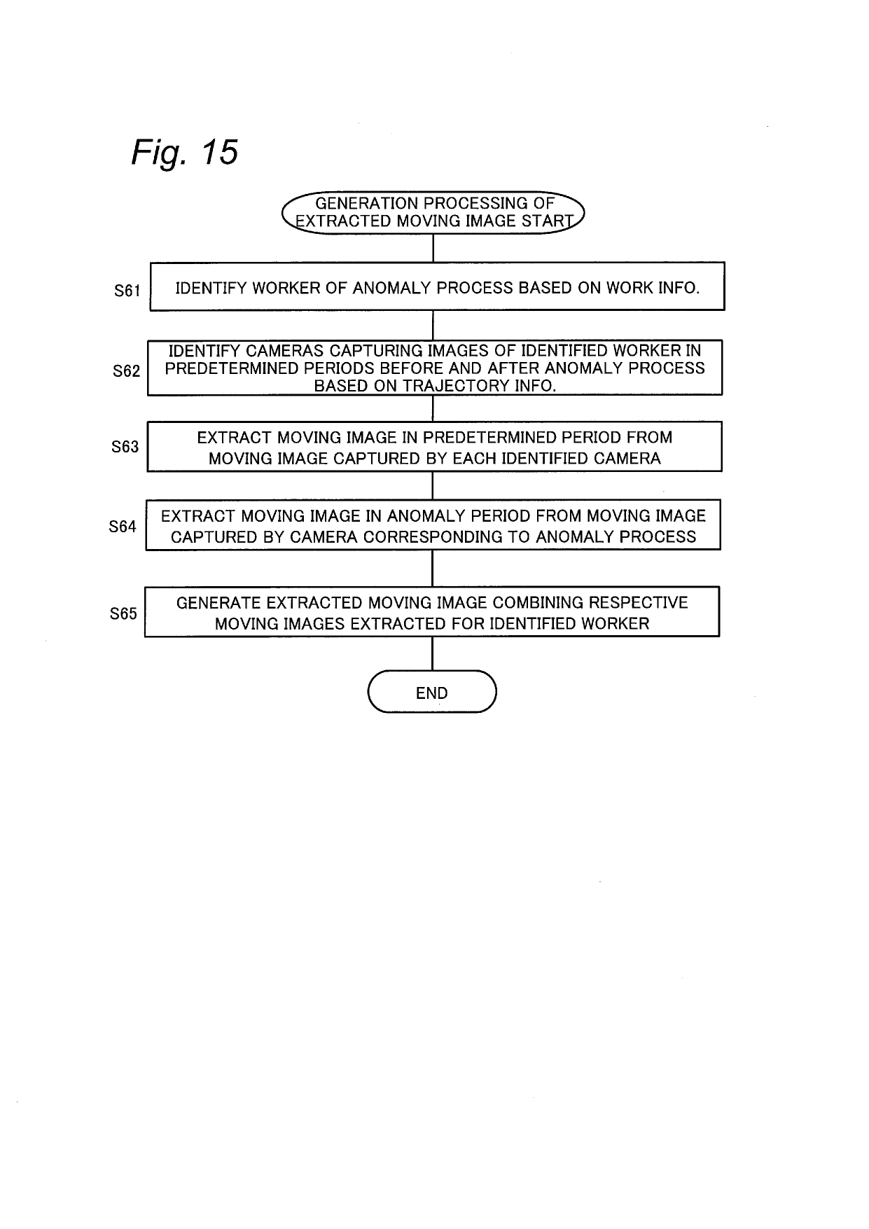

In the first modification described above, the example in which the moving images from the camera 2 corresponding to the anomaly process and the cameras 2 having the adjacent image capturing ranges in the work site 6 is included in the extracted moving image based on the camera positions in the process information D3 is described. The extracted moving image may include, for example, a moving image of a process performed at a position where the worker W1 has performed the work before and after the anomaly process according to a trajectory indicating a locus of movement of the worker W1 in the work site 6. Such a second modification of the first embodiment will be described with reference to FIG. 15.

FIG. 15 is a flowchart illustrating the generation processing of the extracted moving image in the second modification of the first embodiment. The processing of the flowchart in FIG. 15 is performed instead of, for example, the generation processing of the extracted moving image in the first embodiment (S15 in FIG. 7, FIG. 11) .

First, the controller 50 identifies the worker performing the work for the anomaly process based on the work information D1 in which the process performed at each time is recorded for each worker, for example (S61).

Next, the controller 50 identifies cameras 2 capturing images of the worker in a predetermined period before and after the anomaly process among all cameras 2 based on trajectory information indicating the trajectory of the worker identified in step S61, for example (S62). In the present modification, for example, an omnidirectional camera or the like is installed to capture an image of the entire range in which each worker performs work in the work site 6. For example, before the start of this flowchart, the work analysis device 5 generates trajectory information indicating the position of each identified worker at each time by image recognition processing on the moving image based on moving image data indicating the moving image captured by the omnidirectional camera in the analysis period. Trajectory information is stored in storage 51a, for example.

Furthermore, in the present modification, the image capturing range of each camera 2 in the work site 6 may be stored in the process information D3 or the like. In step S62, the controller 50 identifies the camera 2 having the image capturing range including the position from the position of the worker in the trajectory information, for example.

The controller 50 extracts a moving image in a predetermined period from the moving images from the cameras 2 identified in step S62 (S63).

The controller 50 extracts the moving image in the anomaly period from the moving image from the camera 2 corresponding to the anomaly process (S64).

The controller 50 combines the moving images extracted in steps S63 and S64 in the order of the time at which the worker identified in step S61 appears, for example, to generate the extracted moving image (S65).

According to the above processing, the extracted moving image including the moving image in which the worker appears before and after the anomaly process is generated according to the trajectory of the worker performed the work for the anomaly process (S61 to S65). According to such an extracted moving image, for example, even in a case where the anomaly state of the anomaly process is caused by the action of the worker, the work can be easily analyzed for the user 3. In the above processing, an example of extracting a moving image before and after the anomaly process is described (S62, S63), but not limited to before and after the anomaly process, a moving image before or after the anomaly process may be extracted.

In the description of the modifications 1 and 2 described above, an example in which the generation of the extracted moving image illustrated in the flowcharts of FIGS. 13 and 15 is performed instead of the generation processing of the extracted moving image (S15 in FIG. 7, FIG. 11) of the first embodiment is described. However, the generation may be performed in combination with the processing of the first embodiment. As described above, in the present embodiment, in addition to the moving image in the anomaly period, the controller 50 extracts the moving image from the camera 2 associated with at least one of: the processes performed before and after the anomaly process; and the process performed in process areas near the process area where the anomaly process is performed (S44, S45, S52, S63).

Effects As described above, the work analysis device 5 of the present embodiment is an example of an image analysis device for analyzing a moving image obtained by capturing an image of the work site 6 (an example of a site) where the processes A to C are performed as an example of a plurality of processes, the moving image being captured by the camera 2 (an example of one or more cameras). The work analysis device 5 includes a storage 51 and a controller 50. The storage 51 stores moving image data D0 indicating a captured moving image of a process area in which the processes A to C are performed in the work site 6. The controller 50 detects anomaly periods A1 to A4 and the like in which a progress status of the plurality of processes A to C deviates from a predetermined reference set for each process in the plurality of processes A to C, based on work information D1 (an example of status information) indicating the progress status (S12). The controller 50 extracts, from the captured moving image indicated by the moving image data D0, a moving image (an example of the first moving image) of a first process area and a second moving image related to the first moving image, based on the detected anomaly period, the first process area including a place where an anomaly process (an example of a first process) is performed in the anomaly period (S15). The second moving image includes one or both of an image capturing result of a second process area located near the first process area and an image capturing result of a pre-process and/or post-process, as an example of a second process performed in at least one of a preceding period before the abnormal process and a subsequent period after the anomaly process (see FIGS. 11 to 15, S41 to S42, S44 to S45, S51 to S52, S62 to S63).

According to the work analysis device 5 described above, the anomaly period in the progress status of work for each of the processes A to C performed by the worker W1 is detected based on the work information D1 (S12). Then, for the detected anomaly period, the moving image of the process area where the anomaly process is performed in the anomaly period is extracted as the first moving image from the captured moving image obtained by image capturing of the work site 6 by the camera 2 (S15). Furthermore, from the captured moving image, a process area located near the process area of the anomaly process and/or a moving image of a process performed before and/or after the anomaly period are extracted as the second moving image (S15). With the first and second moving images extracted in this manner, for example, even in a case where there is a factor of an anomaly state in the vicinity of the process area of the anomaly process and/or before and after the anomaly period, the processes performed in the work site 6 can be easily analyzed.

In the present embodiment, the work site 6 is captured by a plurality of cameras 2. The storage 51 stores process information D3 as an example of process association information in which at least one of the plurality of cameras 2 is associated with each process in the plurality of processes A to C according to the process area of each process. The controller 50 extracts the first moving image in the anomaly period from a moving image captured by a camera 2 associated with the anomaly process among the plurality of cameras 2 (S43, S53, S64), and extracts the second moving image from a moving image captured by a camera 2 associated with at least one of: a process performed in the process area as an example of the second process area near the first process area where the anomaly process is performed; and each of processes performed before and after the anomaly period (each as an example of the second process) (S44, S45, S52, S63), based on the process information D3 (S15).

Therefore, by identifying a process in the work analysis device 5, for example, a moving image showing a process area of the process can be extracted by simple processing with reference to the process information D3. In addition, the user 3 can analyze such an extracted moving image which is captured by some cameras 2 associated with the anomaly process and the like among the plurality of cameras 2. Such extraction facilitates analyzing the work.

In the present embodiment, the controller 50 generates the extracted moving image V6 (an example of a combined moving image) by combining the moving images V1 to V3, based on the moving image data indicating the moving image V2 as an example of the first moving image in the anomaly period and the moving image data indicating the moving images V1 and V3 each as an example of the second moving image related to the first moving image (see S46, FIG. 12). Furthermore, similarly to step S46, the extracted moving image is also generated by the processing of step S54 of FIG. 13 and step S65 of FIG. 15. According to such an extracted moving image, for example, the user 3 can collectively analyze a moving image of the anomaly period and the moving image related to the anomaly period.

In the first modification of the present embodiment, a moving image from the nearby camera, as an example of the second moving image, includes a moving image in which a process area adjacent to the process area of the anomaly process (an example of a first process area) in the work site 6 is captured as the second process area (S51, S52). Therefore, the moving image of the process area located in the vicinity of the process area of the anomaly process in the work site 6 can be extracted.

In the second modification of the present embodiment, the controller 50 extracts, as an example of the second moving image, a moving image from the camera 2 capturing an image of the worker W1 (an example of an operator) in a predetermined period for each of pre-process and post-process respectively before and after the anomaly process, based on the trajectory information indicating a position of the worker W1 in the work site 6 for each time (S62, S63). The second moving image includes a moving image of a position where the process before and/or after the anomaly process is performed by the worker W1. Therefore, the moving image of processes/a process performed before and/or after the anomaly process at the position in the trajectory of the worker W1 can be extracted.

In the present embodiment, the controller 50 generates the work information D1 by image recognition processing based on the moving image data D0 (S2, S3). The work information D1 includes information indicating a process at each time performed in the work site 6 among the processes A to C. Therefore, in addition to presenting the moving image data D0 to the user 3, the moving image data D0 can also be used for generating the work information D1. In the present embodiment, for example, even when the work analysis system 1 does not include the sensor 9 and the like, the performed process can be analyzed.

In the present embodiment, the work analysis device 5 further includes the user interface 53 that inputs a user operation to set an extraction condition on extracting a moving image from the captured moving image. The controller 50 extracts the moving image in the anomaly period and the nearby moving image (an example of the first moving image and the second moving image, respectively) from the captured moving image according to the user operation input via the user interface 53 (see S14, S15, FIG. 8). Therefore, the user 3 can conduct analysis using the moving image extracted from the captured moving image according to a desired condition, and the work can be easily analyzed from the captured moving image.

In the present embodiment, the storage 51 stores, as a predetermined reference, the normal state information D2 (an example of reference information) including at least one of the standard work period (an example of a length of time during which each of the processes A to C is performed), the process sequence (an example of a sequential order in which each process is performed among the processes A to C), and the work interval (an example of a time interval between two processes among the processes A to C). The controller 50 detects the anomaly period by comparing the work information D1 with the normal state information D2 (S12, S23 to S25). The reference in the normal state information D2 may be updated, for example, according to a predetermined user operation or statistical analysis of the work information D1.

In the present embodiment, according to the operation of the work analysis device 5 as described above, a work analysis method is provided as the image analysis method for analyzing a moving image captured by the camera 2 (an example of one or more cameras) in the work site 6 in which processes A to C are performed as an example of a plurality of processes. The storage 51 of the work analysis device 5 (an example of a computer) stores the moving image data D0 indicating a captured moving image of a process area in which each of the processes A to C is performed in the work site 6. The controller 50 detects anomaly periods A1 to A4 and the like in which a progress status of the plurality of processes A to C deviates from a predetermined reference set for each process in the plurality of processes A to C, based on the work information D1 indicating the progress status (S12). The controller 50 extracts, from the captured moving image indicated by the moving image data D0, a moving image of a first process area (an example of the first moving image) and a second moving image related to the first moving image, based on the detected anomaly period, the first process area including a place where the anomaly process (an example of a first process) is performed in the anomaly period (S15). The second moving image includes at least one of an image capturing result of a second process area located near the first process area and an image capturing result of a second process performed before and/or after the anomaly process (see FIGS. 11 to 15, S41 to S42, S44 to S45, S51 to S52, S62 to S63).

In the present embodiment, a program for causing the work analysis device 5, as an example of a computer, to execute the work analysis method as described above is provided. The work analysis method and the program described above facilitates analyzing the processes performed in the work site 6 from the moving image obtained by image capturing of the work site 6 by the camera 2.

(Second Embodiment) In the first embodiment, the work analysis device 5 that detects an anomaly period using the work information D1 generated based on the moving image data D0 is described. In the second embodiment, a work analysis device 5 that detects an anomaly period using work information D1 generated based on sensor data from the sensor 9 in a work analysis system 1 will be described.

Hereinafter, description of configurations and operations similar to those of the work analysis system 1 and the work analysis device 5 of the first embodiment will be omitted as appropriate, and the work analysis system 1 and the work analysis device 5 of the present embodiment will be described.

1. Overview of work analysis system In the work analysis system 1 illustrated in FIG. 1, the sensors 9-1 to 9-3 are provided corresponding to the respective processes A to C. In the work analysis device 5 of the present embodiment, for example, in the process information D3 (see FIG. 4B), the sensors 9-1, 9-2, and 9-3 are managed in association with the processes A, B, and C, respectively.

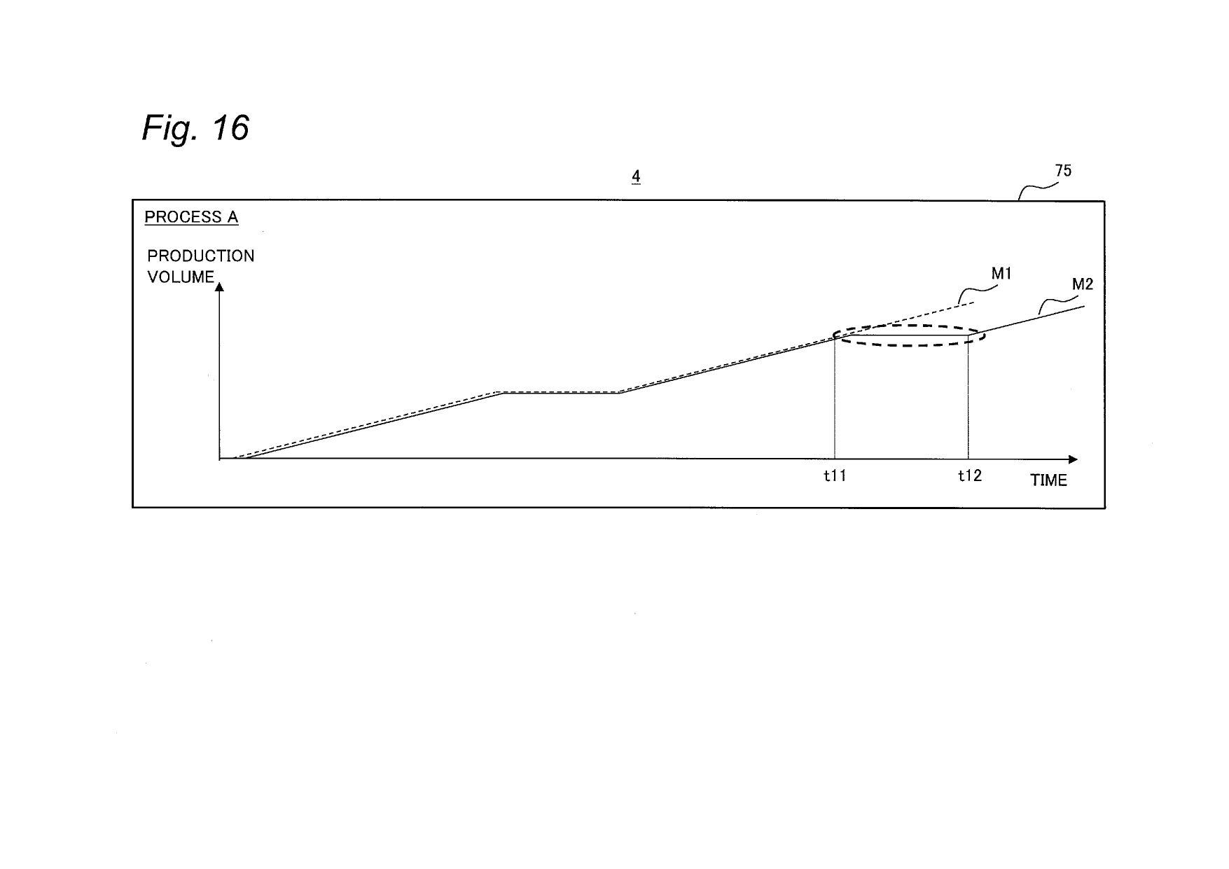

FIG. 16 is a diagram for describing an overview of an operation of the work analysis system 1 in second embodiment. In the work analysis system 1 of the present embodiment, the work analysis device 5 receives, from each sensor 9, sensor data indicating a detection result of the article 8 passing through a position where each of the processes A to C ends in the work site 6, and calculates the number of passing articles 8 for each of the processes A to C. The work analysis device 5 causes the monitor 4 to display a production volume graph indicating the number of articles 8 produced at each time based on the number of passages in each of the processes A to C. FIG. 16 illustrates a production volume graph 75 for process A.

The production volume graph 75 displays a production plan M1 indicating the target production volume at each time in the work site 6 and a production performance M2 indicating the production volume calculated from the number of articles 8 passing through each of the processes A to C at each time. In the example of FIG. 16, an anomaly state in which the production volume of the production performance M2 deviates from the production volume in the production plan M1 occurs in a period from the time t11 to the time t12. The work analysis device 5 of the present embodiment detects such a period from the time t11 to the time t12 as the anomaly period. A planned production volume such as the target production volume for each time is stored in the storage 51a in advance as, for example, the normal state information D2 in the present embodiment.

2. Operation of work analysis device In the work analysis device 5 of the present embodiment, for example, the controller 50 functioning as the work detector 502 calculates the production volume of the article 8 at each time based on the sensor data from the sensor 9, thereby generating the work information D1. For example, in step S1 of FIG. 6, in addition to the image data for each frame, sensor data at the timeframe time of the frame may be acquired. In the work information D1, for example, the production volume for each time is stored for each of the processes A to C.

In the present embodiment, the controller 50 may not particularly execute image recognition processing (S2 in FIG. 6) for detecting the processes A to C based on the moving image data D0. Furthermore, for example, in step S3 of FIG. 6, the controller 50 may record the frame time of each frame of the moving image data D0 and the process corresponding to the sensor 9 in association with each other in the work information D1, according to the sensor 9 acquiring the sensor data at the frame time.

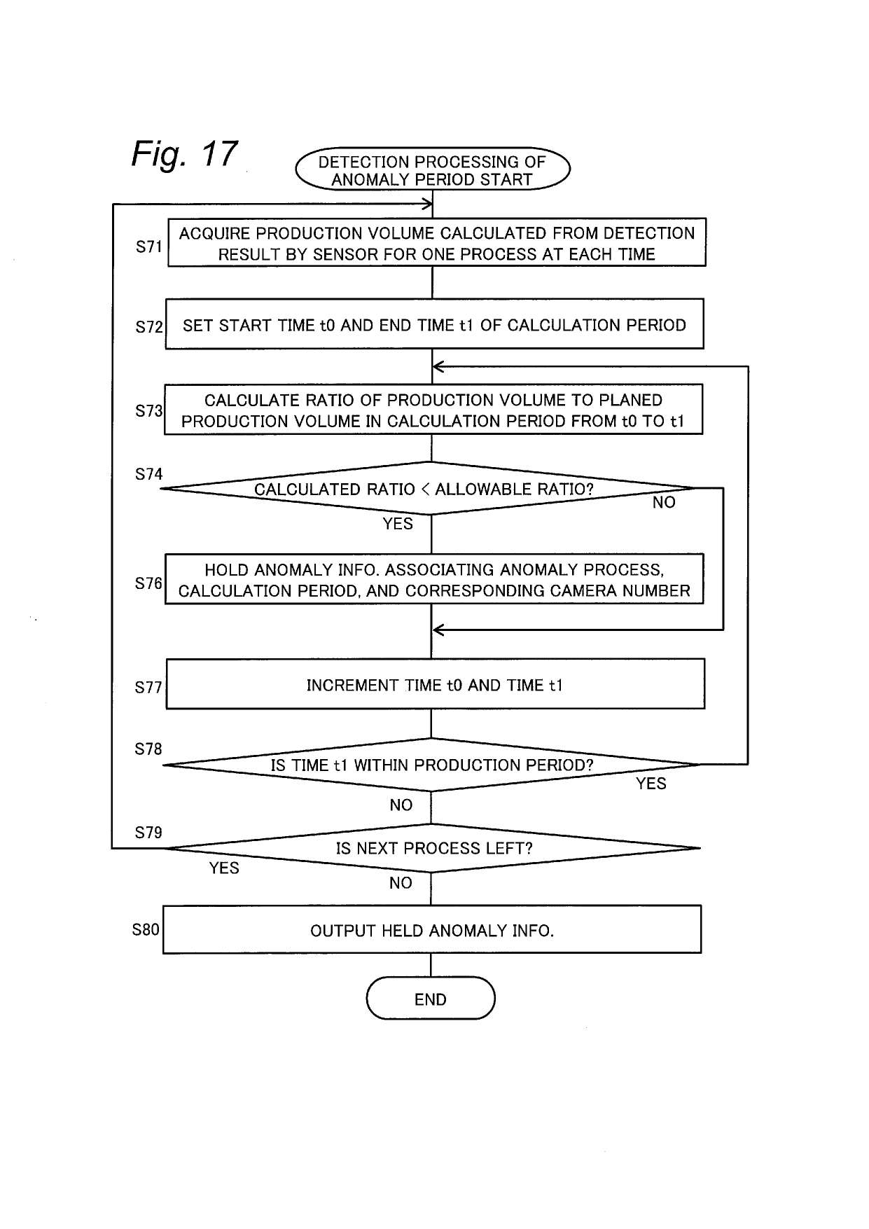

FIG. 17 is a flowchart illustrating the detection processing of the anomaly period in the work analysis device 5 of the second embodiment. The processing of this flowchart is performed, for example, instead of the processing of step S12 of the first embodiment in the operations (FIG. 7) of the anomaly detector 503 and the moving image extractor 504.

First, the controller 50 acquires the production volume produced at each time calculated from the detection result of the corresponding sensor 9 for one process from, for example, the work information D1 (S71).

Next, the controller 50 sets the start time t0 and the end time t1 of a calculation period for calculating throughput of the article 8, for example (S72). The end time t1 is set, for example, n seconds (n is a positive number) after the start time t0 by a predetermined period.

The controller 50 calculates a ratio of the cumulative production volume to the planned production volume in the calculation period set in step 71, that is, from time t0 to time t1 based on, for example, the production volume at each time acquired in step S72 and the normal state information D2 (S73).

The controller 50 determines whether the ratio calculated in step S73 is less than the predetermined allowable ratio (S74). The predetermined allowable ratio is set, for example, from a viewpoint of detecting an anomaly state in which the production speed of the article 8 is slower than the production plan M1 and the production volume in the calculation period deviates from the planned production volume.

When the calculated ratio is less than the predetermined allowable ratio (YES in S74), the controller 50 sets the process of a calculation target of the ratio as the anomaly process, and holds the anomaly information in which the calculation period and the camera number corresponding to the process are associated with each other in the temporary storage 51b based on the process information D3 (S76).

On the other hand, when the calculated ratio is not less than the predetermined allowable ratio (NO in S74), the controller 50 increments each of the start time t0 and the end time t1 of the calculation period (S77).

The controller 50 refers to, for example, the normal state information D2, and determines whether or not the incremented end time t1 is equal to or less than the end time of the work in the production plan in the work site 6, that is, within the production period(S78).

In a case where the time t1 is within the production period (YES in S78), the controller 50 repeats the processing in and after step S73 in the computation period from the incremented time t0 to t1.

When the time t1 is not within the production period (NO in S78), the controller 50 determines whether, for example, the work information D1 includes a process subsequent to the process of acquiring the production volume in step S71, that is, whether a next process is left (S79).

When the next process is left (YES in S79), the controller 50 executes the processing in and after step S71 for the process.

When the next process is not left (NO in S79), the controller 50 outputs, for example, the anomaly information held in the temporary storage 51b from the anomaly detector 503 to the moving image extractor 504 (S80). Thereafter, the controller 50 ends the processing of this flowchart.

According to the above processing, for each process, when the ratio of the production volume to the planned production volume in the calculation period is less than the allowable ratio (YES in S74), anomaly information regarding processes, and the likw. is held (S76). Therefore, it is possible to detect the anomaly state in which the production volume to be produced deviates from the planned production volume, for example, production of the article 8 in the work site 6 is delayed, and generate the extracted moving image similarly to the first embodiment. In the above processing, for example, after step S74, the controller 50 may determine whether or not the difference between the cumulative planned production volume from the start of the process to be calculated to the time t1 and the production volume is less than a predetermined allowable number, and hold the anomaly information in a case where the difference is not less than the allowable number.

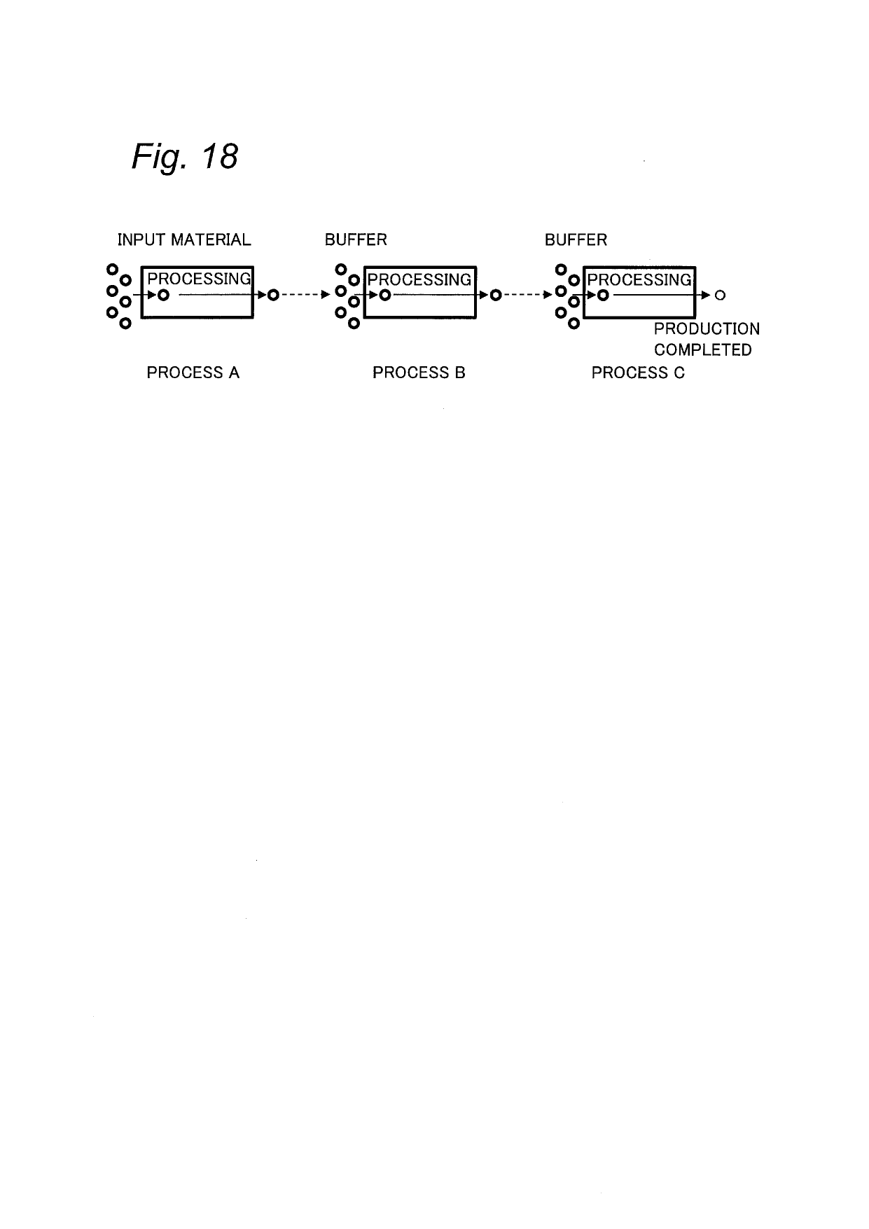

FIG. 18 is a diagram for describing generation of the extracted moving image in the work analysis device 5 of the second embodiment. FIG. 18 illustrates an example in which work such as production of the article 8 is performed in the order of the processes A, B, and C from materials input to the equipment or the like of the work site 6. In the example of FIG. 18, a workpiece processed in the pre-process is further processed in the post-process. In such a situation, for example, when an anomaly state in which production is delayed occurs in one process, it is assumed that there is a factor in a process immediately before the process. Therefore, the work analysis device 5 of the present embodiment generates the extracted moving image from, for example, the moving image of the process in which the anomaly state occurs and the moving image of the immediately pre-process.

For example, in a case where an anomaly state in which the production of the process A is delayed is detected, a moving image from the camera 2-1 corresponding to the process A among the cameras 2-1 to 2-3 is extracted. As a result, the moving image of the process A in which the factor of the anomaly state is assumed can be analyzed. Furthermore, in a case where the production of the process B is delayed, moving images from the cameras 2-1 and 2-2 corresponding to the processes A and B are extracted. In this case, it is assumed that the production of the process A for outputting the workpiece to the process B is delayed, or the production itself of the process B is delayed. According to the extracted moving image in the present embodiment, for example, the user 3 can analyze the moving image of the process B in addition to the moving image of the process A, and can easily analyze the work.

As described above, in the present embodiment, the controller 50 generates the work information D1 based on the sensor data obtained by detecting the article 8 (an example of an object) by the sensor 9 in the work site 6 at each time, the processes A to C (an example of the plurality of processes) being sequentially performed on the article 8. The work information D1 includes information indicating the number of articles 8 detected by each time in the sensor data. According to such generation of the work information D1, for example, processing load in the work analysis device 5 can be reduced as compared with a case of generating the work information D1 by analyzing the moving image data captured by the camera. In addition, a cost for realizing the work analysis system 1 can be reduced.

In the present system 1, the worker W1 is not limited to a person, and may be a device or the like that executes work for each process. In this case, instead of the sensor data, the work information D1 may be generated based on log information or the like from the device. Furthermore, in the present embodiment, an example in which the detection processing of the anomaly period (FIG. 17) is performed instead of the processing of step S12 of the first embodiment is described, but both the processing of the flowchart of FIG. 17 and the processing of step S12 may be performed.

(Other Embodiments) As described above, the first and second embodiments are described as an example of the technique to be disclosed in the present application. However, the technique in the present disclosure is not limited thereto, and can also be applied to exemplary embodiments in which changes, replacements, additions, omissions, and the like are made as appropriate. In addition, it is also possible to combine the components described in the above embodiments to form a new embodiment. Therefore, other embodiments will be exemplified below.

In each of the above embodiments, an example is described in which the work analysis device 5 accumulates the moving image data D0 in the analysis period, and then generates the extracted moving image. In the present embodiment, the extracted moving image may be generated in real time while acquiring the moving image data from each camera 2. The work analysis device 5 of the present embodiment may hold moving image data of a predetermined period shorter than the analysis period in the temporary storage 51b, for example, and execute operations (see FIG. 6) of the moving image obtainer 501 and the work detector 502 based on the moving image data. For example, instead of step S5 in FIG. 6, it may be determined whether or not the acquisition of each frame in the predetermined period ends, and the processing of step S1 and subsequent steps may be repeated until the acquisition ends.

For example, the work analysis device 5 of the present embodiment may notify, from the work detector 502 to the anomaly detector 503, switching of the detected processes, and execute the operations of the anomaly detector 503 and the moving image extractor 504 (see FIG. 7) based on the held moving image data for each process. In this case, in the detection processing of the anomaly period (S12 in FIG. 7), for example, instead of step S21 in FIG. 10, the work information in the period of each process may be acquired, and the processing of steps S22 and S27 may not be performed. Further, for example, in step S13 of FIG. 7, the setting screen 71 (see FIG. 8) may be displayed to sequentially update the work time graph.

In each of the above embodiments, an example is described in which the work information D1 is generated based on either the moving image data from the camera 2 or the sensor data from the sensor 9. In the present embodiment, the work information D1 may be generated based on both the moving image data and the sensor data, and may include, for example, information indicating a process of work performed by the worker W1 for each time and the production volume of articles 8 for each time.

In the first embodiment described above, an example in which the work analysis system 1 includes the sensor 9 is described. In the present embodiment, the work analysis system may not particularly include the sensor 9. Also in this case, for example, an operation similar to that of the work analysis system 1 of the first embodiment can be performed.

In the first embodiment described above, an example is described in which the work analysis device 5 extracts the moving images of the pre-process and the post-process of the anomaly process for the predetermined period N seconds in the generation processing of the extracted moving image (S15) (S44, S45). In the present embodiment, the periods for extracting the moving images of the pre-process and the post-process may be different depending on the type of the anomaly state in the anomaly process. For example, a priority may be set to each type of the anomaly state, and the higher priority a type has, the longer period a moving image extracted for the type has. As a result, in such a plurality of types of anomaly states, a type of anomaly state having a higher priority can be easily analyzed in detail from the extracted moving image. For example, a higher priority may be set to the anomaly state in which the work period of the process is too long than a priority set to the anomaly state in which the work period is too short, in comparison with the standard work period.

In the first modification of the first embodiment, an example is described in which the camera 2 within the predetermined range from the camera position of the camera 2 corresponding to the anomaly process is identified as the nearby camera in the generation processing of the extracted moving image (S51). In the present embodiment, for example, similarly to the above-described embodiment, the priority may be set to each type of anomaly state, and a camera 2 within a wider range may be identified as the nearby camera as the priority of the type becomes higher.

In the first embodiment described above, an example is described in which the controller 50 of the work analysis device 5 detects whether or not work is performed for each of the processes A to C as the work detector 502. The controller 50 as the work detector 502 is not limited to the above example, and may execute image classification processing classifying, for example, which of the processes A to C is shown in each frame image and whether no detection target is shown.

In each of the above embodiments, the example in which the anomaly period is detected from the entire analysis period based on the work information D1 of the analysis period in the detection processing of the anomaly period (S12) is described. In the present embodiment, a period during which no anomaly period is detected may be set in the analysis period. For example, after step S22 in FIG. 10, the controller 50 may determine whether or not the selected process corresponds to the set period, and may proceed to processing of step S23 and subsequent steps in a case where the selected process does not correspond to the set period, and may proceed to step S27 in a case where the selected process corresponds to the set period. Therefore, for example, a period such as a break time in the work site 6 can be set so as not to be detected as an anomaly period, and analysis can be facilitated.

In each of the above embodiments, an example in which the work analysis system 1 includes the three cameras 2-1 to 2-3 is described. In the work analysis system of the present embodiment, the number of cameras is not limited to three, and may be, for example, two or less or four or more. In addition, each process of work in the work site 6 and each camera may not correspond one-to-one. For example, two or more processes may be captured by one camera. The process information D3 is not limited to the example of FIG. 4B, and may be any information as long as it associates the image capturing range of the camera in the work site 6 with the process area where each process is performed.

In each of the above embodiments, in order to enable analysis for each worker in the work analysis system 1, for example, an example of identifying each worker at the time of detection of a process performed in the work site 6 (S2 in FIG. 6) is described. In the present embodiment, analysis may be performed without particularly distinguishing a plurality of workers, and the worker may not be identified in detection of a process or the like.

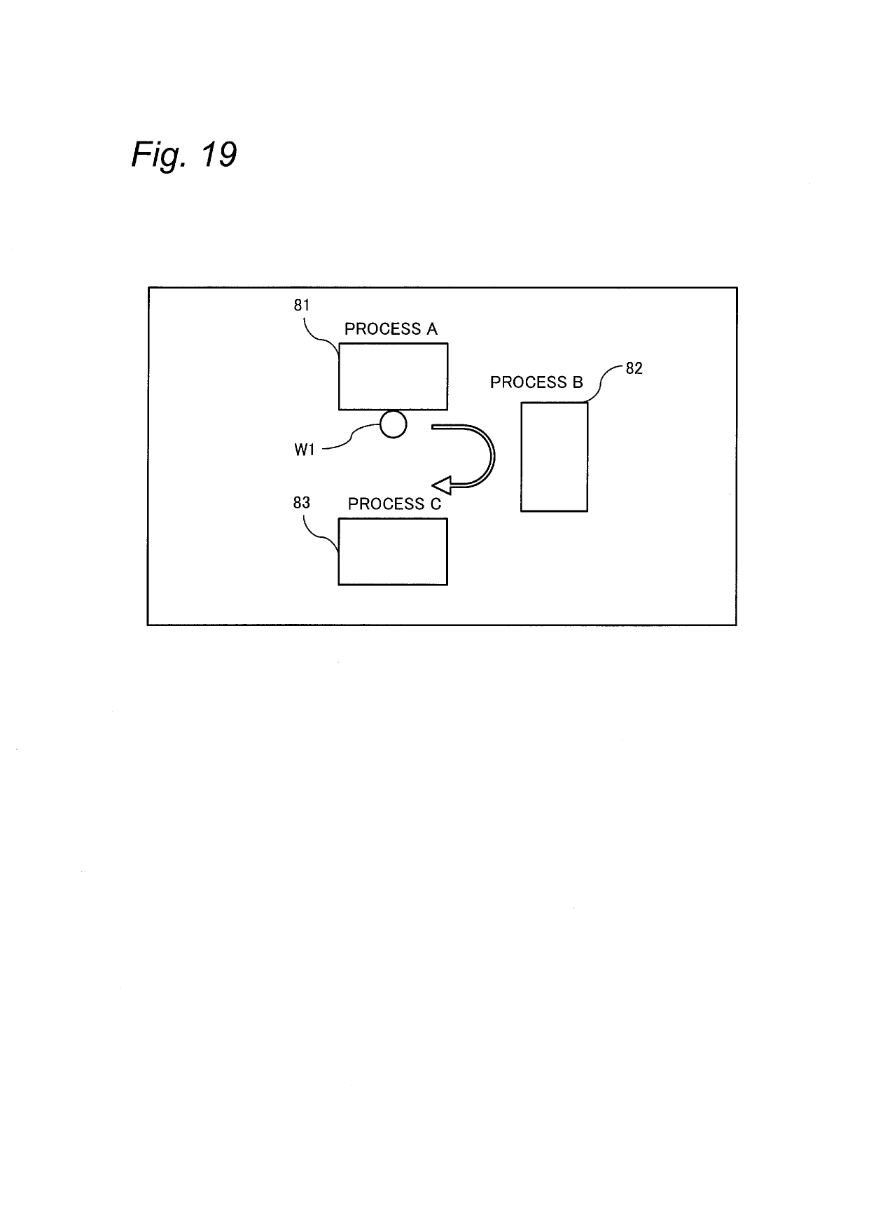

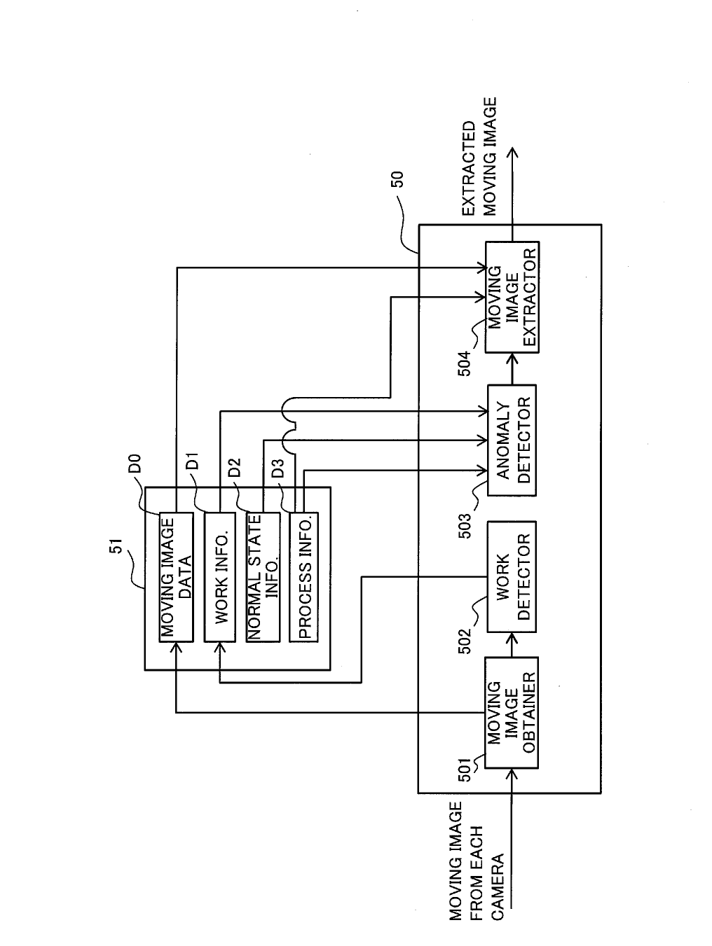

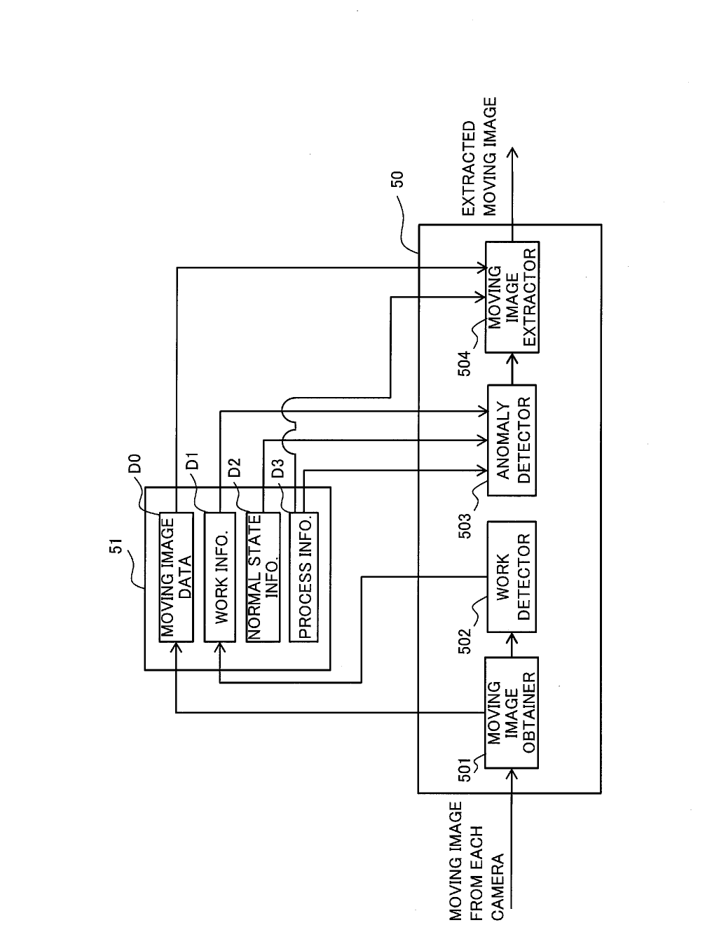

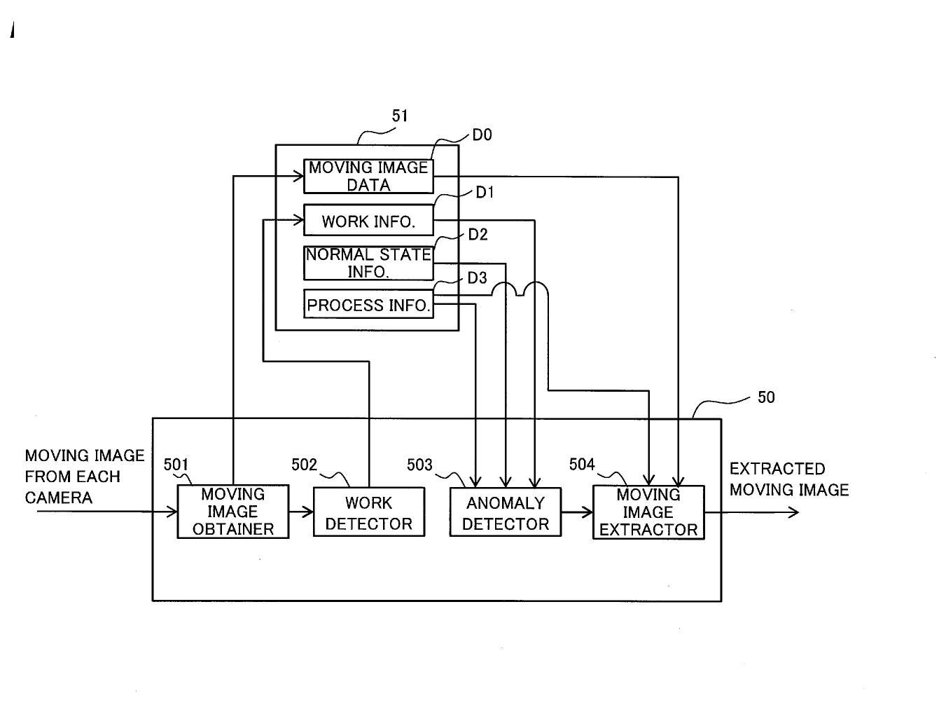

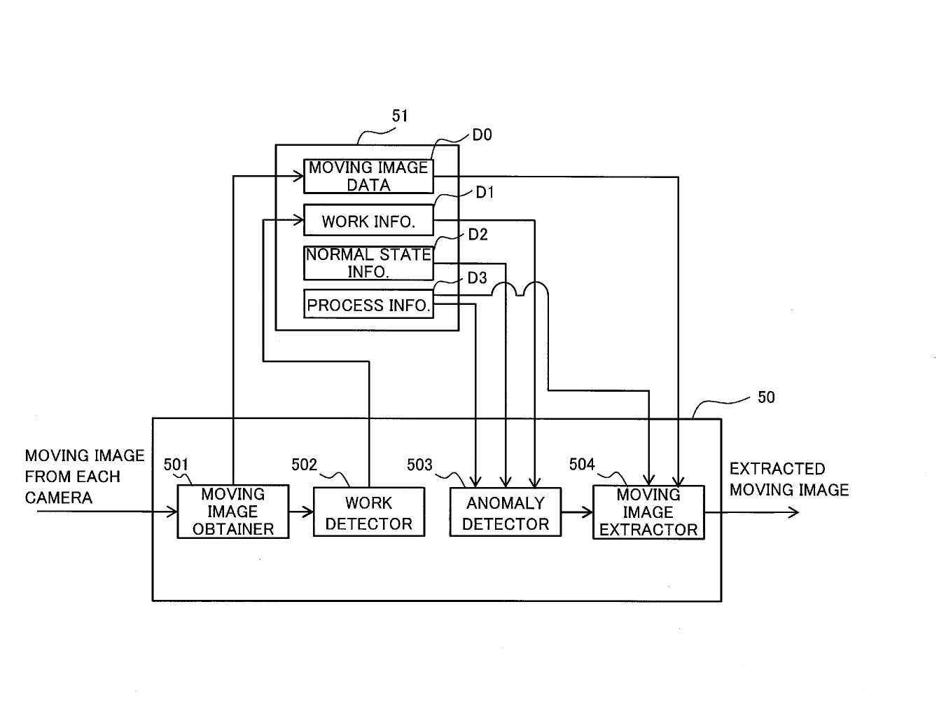

In each of the above embodiments, an example in which the work analysis system 1 is applied to the work site 6 having the conveyor line 61 is described. The work site 6 to which the work analysis system 1 is applied is not limited to the above-described example, and may be applied to, for example, a work site where cell production is performed. Such a modification will be described with reference to FIG. 19. FIG. 19 is a diagram for describing a work site to which the work analysis system 1 is applied in a further modification of the first embodiment. In the work site of the present modification, three workbenches 81, 82, and 83 are provided corresponding to the work processes A, B, and C, respectively. For example, the worker W1 sequentially performs the processes A to C on the respective workbenches 81 to 83.

Also in the work site of the present modification, for example, the cameras 2-1 to 2-3 are disposed to capture the process area of the processes A to C on the respective workbenches 81 to 83, and the work can be analyzed from the moving image captured by each camera 2 as in each of the above embodiments. In this case, for example, when the process A is performed in the anomaly period in the generation processing of the extracted moving image (FIG. 13) similar to that of the first modification of the first embodiment, the extracted moving image may include the moving image of the process C as the process performed in the vicinity of the process A. In the present modification, the work for processes A to C is not limited to one worker W1, and may be performed by a plurality of workers. In FIG. 14, a work site provided with one cell including the workbenches 81 to 83 is illustrated, but the present system 1 is also applicable to a work site provided with a plurality of cells.

In each of the above embodiments, an example in which the work analysis system 1 is applied to the work site 6 such as a factory is described. In the present embodiment, a work site to which the work analysis system 1 and the work analysis device 5 are applied, that is, a site is not limited to the above-described work site 6, and may be various sites such as a distribution warehouse or a store floor. The work determined by the work analysis system 1 is not limited to the above-described example, and may be various works corresponding to various sites. For example, the present disclosure may be applied to analysis of work including processes such as pickup and packing for the article 8 such as a package at a site of a distribution warehouse.

In each of the above embodiments, an example in which the work analysis system 1 is applied to a person such as the worker W1 is described. In the present embodiment, the worker to be analyzed by the work analysis system 1 may be a moving object capable of executing various works, or may be a production facility or the like provided for each work. For example, the moving object may be a robot, or may be various manned or unmanned vehicles.

As described above, the above-described embodiment is described as an example of the technique of the present disclosure. To that end, the accompanying drawings and detailed description are provided.

Therefore, the components described in the drawings and the detailed description may include not only components essential for solving the problem but also components that are not essential for solving the problem in order to illustrate the above-described technology. Therefore, it should not be immediately recognized that these non-essential components are essential based on the fact that these non-essential components are described in the drawings and the detailed description.

### (Aspects of the present disclosure)

Hereinafter, aspects of the present disclosure will be exemplified.

A first aspect is an image analysis device for analyzing a moving image captured by one or more cameras in a site where a plurality of processes is performed. The image analysis device includes: a storage that stores moving image data indicating a captured moving image of a process area in which each process is performed in the site; and a controller that detects an anomaly period in which a progress status of the plurality of processes deviates from a predetermined reference set for each process in the plurality of processes, based on status information indicating the progress status. The controller extracts, from the captured moving image indicated by the moving image data, a first moving image of a first process area and a second moving image related to the first moving image, based on the detected anomaly period, the first process area including a place where a first process is performed in the anomaly period. The second moving image includes one or both of: an image capturing result of a second process area located near the first process area; and an image capturing result of a second process performed in at least one of a preceding period before the first process and a subsequent period after the first process.

A second aspect is the image analysis device according to the first aspect, wherein the site is captured by a plurality of cameras. The storage stores process association information that associates at least one of the plurality of cameras with each process in the plurality of processes according to a process area of each process. The controller extracts the first moving image from a moving image captured by a camera associated with the first process among the plurality of cameras, and extracts the second moving image from a moving image captured by a camera associated with at least one of a process performed in the second process area or the second process among the plurality of cameras, based on the process association information.

A third aspect is the image analysis device according to the first or second aspect, wherein the controller generates a combined moving image by combining the first moving image and the second moving image based on moving image data indicating the extracted first moving image and moving image data indicating the extracted second moving image.

A fourth aspect is the image analysis device according to any of the first to third aspects, wherein the second moving image includes a moving image in which a process area adjacent to the first process area in the site is captured as the second process area.

A fifth aspect is the image analysis device according to any of the first to fourth aspects, wherein the controller extracts the second moving image further based on trajectory information indicating a position of an operator in the site at each time. The second moving image includes a moving image of a position where the second process is performed in at least one of the preceding period and the subsequent period of the first process.

A sixth aspect is the image analysis device according to any of the first to fifth aspects, wherein the controller generates the status information by image recognition processing based on the moving image data. The status information includes information indicating a process performed at each time in the site among the plurality of processes.

A seventh aspect is the image analysis device according to any of the first to sixth aspects, wherein the controller generates the status information based on sensor data obtained by detecting an object by a sensor in the site at each time, the plurality of processes being sequentially performed on the object. The status information includes information indicating the number of objects detected by each time in the sensor data.

A eighth aspect is the image analysis device according to any of the first to seventh aspects, further comprising a user interface that inputs a user operation to set an extraction condition on extracting a moving image from the captured moving image. The controller extracts the first moving image and the second moving image from the captured moving image according to the user operation input via the user interface.

A ninth aspect is the image analysis device according to any of the first to eighth aspects, wherein the storage stores, as the predetermined reference, reference information including at least one of a length of time during which each process in the plurality of processes is performed, a sequential order in which each process is performed among the plurality of processes, or a time interval between two processes among the plurality of processes. The controller detects the anomaly period by comparing the status information with the reference information.

A tenth aspect is an image analysis method for analyzing a moving image captured by one or more cameras in a site where a plurality of processes is performed, wherein: a storage of a computer stores moving image data indicating a captured moving image of a process area in which each process is performed in the site. The image analysis method including, by a controller of the computer: detecting an anomaly period in which a progress status of the plurality of processes deviates from a predetermined reference set for each process in the plurality of processes, based on status information indicating the progress status; and extracting, from the captured moving image indicated by the moving image data, a first moving image of a first process area and a second moving image related to the first moving image, based on the detected anomaly period, the first process area including a place where a first process is performed in the anomaly period. The second moving image includes one or both of an image capturing result of a second process area located near the first process area and an image capturing result of a second process performed in at least one of a preceding period before the first process or a subsequent period after the first process.

A eleventh aspect is a tangible non-transitory computer-readable medium storing a program for causing the controller of the computer to execute the image analysis method according to the tenth aspect.

Industrial Applicability The present disclosure is applicable to data analysis for analyzing processes performed by one or more operators in various environments such as a factory or a distribution site.

What claimed is:

1. An image analysis device for analyzing a moving image captured by one or more cameras in a site where a plurality of processes is performed, the image analysis device comprising:
a storage that stores moving image data indicating a captured moving image of a process area in which each process is performed in the site; and
a controller that detects an anomaly period in which a progress status of the plurality of processes deviates from a predetermined reference set for each process in the plurality of processes, based on status information indicating the progress status,
wherein the controller extracts, from the captured moving image indicated by the moving image data, a first moving image of a first process area and a second moving image related to the first moving image, based on the detected anomaly period, the first process area including a place where a first process is performed in the anomaly period, and
the second moving image includes one or both of an image capturing result of a second process area located near the first process area and an image capturing result of a second process performed in at least one of a preceding period before the first process or a subsequent period after the first process.

2. The image analysis device according to claim 1, wherein the site is captured by a plurality of cameras,
the storage stores process association information that associates at least one of the plurality of cameras with each process in the plurality of processes according to a process area of each process, and
the controller extracts the first moving image from a moving image captured by a camera associated with the first process among the plurality of cameras, and extracts the second moving image from a moving image captured by a camera associated with at least one of a process performed in the second process area or the second process among the plurality of cameras, based on the process association information.

3. The image analysis device according to claim 1, wherein the controller generates a combined moving image by combining the first moving image and the second moving image based on moving image data indicating the extracted first moving image and moving image data indicating the extracted second moving image.

4. The image analysis device according to claim 1, wherein the second moving image includes a moving image in which a process area adjacent to the first process area in the site is captured as the second process area.

5. The image analysis device according to claim 1, wherein the controller extracts the second moving image further based on trajectory information indicating a position of an operator in the site at each time, and
the second moving image includes a moving image of a position where the second process is performed in at least one of the preceding period or the subsequent period of the first process.

6. The image analysis device according to claim 1, wherein the controller generates the status information by image recognition processing based on the moving image data, and
the status information includes information indicating a process performed at each time in the site among the plurality of processes.

7. The image analysis device according to claim 1, wherein the controller generates the status information based on sensor data obtained by detecting an object by a sensor in the site at each time, the plurality of processes being sequentially performed on the object, and
the status information includes information indicating the number of objects detected by each time in the sensor data.

8. The image analysis device according to claim 1, further comprising a user interface that inputs a user operation to set an extraction condition on extracting a moving image from the captured moving image,
wherein the controller extracts the first moving image and the second moving image from the captured moving image according to the user operation input via the user interface.

9. The image analysis device according to claim 1, wherein the storage stores, as the predetermined reference, reference information including at least one of a length of time during which each process in the plurality of processes is performed, a sequential order in which each process is performed among the plurality of processes, or a time interval between two processes among the plurality of processes, and
the controller detects the anomaly period by comparing the status information with the reference information.

10. An image analysis method for analyzing a moving image captured by one or more cameras in a site where a plurality of processes is performed, wherein:
a storage of a computer stores moving image data indicating a captured moving of a process area in which each process is performed in the site;
the image analysis method comprising, by a controller of the computer,
detecting an anomaly period in which a progress status of the plurality of processes deviates from a predetermined reference set for each process in the plurality of processes, based on status information indicating the progress status, and
extracting, from the captured moving image indicated by the moving image data, a first moving image of a first process area and a second moving image related to the first moving image, based on the detected anomaly period, the first process area including a place where a first process is performed in the anomaly period; and
the second moving image includes one or both of an image capturing result of a second process area located near the first process area and an image capturing result of a second process performed in at least one of a preceding period before the first process or a subsequent period after the first process.

11. A tangible non-transitory computer-readable medium storing a program for causing the controller of the computer to execute the image analysis method according to claim 10.
